(19) United States
(12) Patent Application Publication
(10) Pub. No.: US 2026/0183921 A1
(43) Pub. Date: Jul. 2, 2026

(54) POWER TOOL

(71) Applicant: MAKITA CORPORATION, Anjo-shi (JP)

(72) Inventors: Taisei OSAWA, Anjo-shi (JP); Shizuki OKAJIMA, Anjo-shi (JP)

(73) Assignee: MAKITA CORPORATION, Anjo-shi (JP)

(21) Appl. No.: 19/421,639

(22) Filed: Dec. 16, 2025

(30) Foreign Application Priority Data
Dec. 26, 2024 (JP) 2024-231245

(51) Int. Cl. B25F 5/00; B25D 16/00

(52) U.S. Cl. CPC B25F 5/001; B25D 16/006; B25D 2250/255; B25D 2250/301

(57) ABSTRACT

A gear case includes: a cylindrical part having a through hole; and bracket boss parts provided on an outer circumference of the cylindrical part. A motor bracket is fixed to the bracket boss parts by the screws. A switching operation part causes a speed reducing mechanism to change gear shifting by being moved. A switching wire passes through the through hole and couples the switching operation part with the speed reducing mechanism. A switching wire includes: a first wire segment extending from the switching operation part to the cylindrical part; a second wire segment extending along an outer circumferential surface of the cylindrical part from an end of the first wire segment; and a third wire segment extending from an end of the second wire segment and inserted into the through hole. The bracket boss parts are provided at positions other than a first region facing the second wire segment.

### CROSS-REFERENCE TO RELATED APPLICATION(S)

The present application claims priority to and incorporates by reference the entire contents of Japanese Patent Application No. 2024-231245 filed in Japan on Dec. 26, 2024.

### TECHNICAL FIELD

The techniques disclosed in the present teachings relate to a power tool.

### BACKGROUND

A driver drill having a gear shifting function as disclosed in Japanese Laid-open Patent Publication No. 2023-89934 is known in the technical field related to power tools. The reduction ratio of a speed reducing mechanism is changed by moving a speed changing lever to a position for a low-speed mode, a position for a medium-speed mode, or a position for a high-speed mode. Japanese Laid-open Patent Publication No. 2023-89934 discloses that a speed changing lever is coupled, via a switching wire, with an internal gear used for gear shifting, and the internal gear is located at a gear shifting position corresponding to the position of the speed changing lever via the switching wire.

In a state in which the speed changing lever is disposed at a position of any speed mode, the internal gear is held at the gear shifting position by the switching wire. In order to reliably switch the speed mode, it is desired to inhibit the positional shift of a movable portion (internal gear) for gear shifting caused by reaction force from another gear, vibration at the time when a power tool moves, and the like. One non-limiting object of the present teachings is to achieve more reliable gear shifting.

### SUMMARY OF THE INVENTION

In one aspect of the present teachings, a power tool may include a motor, an output part, a speed reducing mechanism, a gear case, a motor bracket, a switching operation part, and a switching wire. The output part may be provided forward of the motor and configured to be driven by the motor. The speed reducing mechanism may be disposed between the motor and the output part and may have a gear shifting function. The gear case may include: a cylindrical part having at least one through hole penetrating therethrough in a radial direction; and a plurality of bracket boss parts provided on an outer circumference of the cylindrical part, and may house the speed reducing mechanism inside the cylindrical part. The motor bracket may be disposed between the motor and the speed reducing mechanism and may be fixed to the bracket boss parts by the screws. The switching operation part may be configured to cause the speed reducing mechanism to change gear shifting by being moved. The switching wire may pass through the through hole of the gear case and may couple the switching operation part with the speed reducing mechanism. The switching wire may include at least one wire portion including first to third wire segments. The first wire segment may extend from the switching operation part to the cylindrical part as viewed from the axial direction. The second wire segment may extend in a circumferential direction along an outer circumferential surface of the cylindrical part from an end of the first wire segment. The third wire segment may extend from an end of the second wire segment and may be inserted into the through hole. The bracket boss parts are provided at positions other than a first region facing the second wire segment in the radial direction, on the outer circumference of the cylindrical part.

In another aspect of the present teachings, a power tool may include: a motor; an output part that is provided forward of the motor and configured to be driven by the motor; a speed reducing mechanism disposed between the motor and the output part and having a gear shifting function; a gear case that includes a cylindrical part having at least one through hole penetrating therethrough in a radial direction and that houses the speed reducing mechanism inside the cylindrical part; a motor bracket disposed between the motor and the speed reducing mechanism and fixed to the gear case by screws; a switching operation part configured to cause the speed reducing mechanism to change gear shifting by being moved; and a switching wire that passes through the through hole of the gear case and couples the switching operation part with the speed reducing mechanism. The switching wire may include a held portion held by the switching operation part. The gear case may include a first screw fixing part, which is provided at a position facing the held portion of the switching wire in the radial direction as viewed from an axial direction and fixes the motor bracket.

According to the techniques disclosed in the present teachings, more reliable gear shifting is achieved.

### BRIEF DESCRIPTION OF THE DRAWINGS

FIG. 1 is a perspective view illustrating a power tool according to an embodiment as viewed from front;

FIG. 2 is a perspective view illustrating the power tool according to the embodiment as viewed from rear;

FIG. 3 is a side view illustrating the power tool according to the embodiment;

FIG. 4 is a cross-sectional view illustrating the power tool according to the embodiment;

FIG. 5 is a cross-sectional view illustrating a part of the power tool according to the embodiment;

FIG. 6 is a perspective view illustrating a part of a speed reducing mechanism according to the embodiment as viewed from right front;

FIG. 7 is a perspective view illustrating a part of the power tool according to the embodiment as viewed from front;

FIG. 8 is a side view illustrating the part of the power tool according to the embodiment;

FIG. 9 is a cross-sectional view illustrating the part of the power tool according to the embodiment;

FIG. 10 is an exploded perspective view illustrating the speed reducing mechanism according to the embodiment as viewed from front;

FIG. 11 is a perspective view illustrating a part of the speed reducing mechanism according to the embodiment as viewed from rear;

FIG. 12 is a side view illustrating a speed changing mechanism according to the embodiment;

FIG. 13 is a perspective view illustrating the speed changing mechanism according to the embodiment as viewed from lower right rear;

FIG. 14 illustrates the power tool in a case where the speed reducing mechanism according to the embodiment is set to a low-speed mode as viewed from above;

FIG. 15 is a cross-sectional view illustrating the speed reducing mechanism in a case where the speed reducing mechanism according to the embodiment is set to the low-speed mode;

FIG. 16 illustrates the power tool in a case where the speed reducing mechanism according to the embodiment is set to a high-speed mode as viewed from above;

FIG. 17 is a cross-sectional view illustrating the speed reducing mechanism in a case where the speed reducing mechanism according to the embodiment is set to the high-speed mode;

FIG. 18 is a horizontal cross-sectional view of a location of engagement between a speed changing lever and a housing as viewed from above;

FIG. 19 is a perspective view illustrating a gear case, a motor bracket, and a gear housing according to the embodiment as viewed from rear;

FIG. 20 is an exploded perspective view illustrating the gear case, the motor bracket, and the gear housing according to the embodiment as viewed from rear;

FIG. 21 is a perspective view illustrating the speed changing lever and a switching wire according to the embodiment as viewed from below;

FIG. 22 is a perspective view illustrating the gear case and the switching wire according to the embodiment as viewed from rear;

FIG. 23 is an arrow view of the gear case and the switching wire according to the embodiment as viewed in the axial direction from rear;

FIG. 24 is an enlarged view of a vicinity of the first wire segment and the second wire segment of the switching wire in FIG. 23;

FIG. 25 is a cross-sectional arrow view of a plane passing through the second wire segments of the switching wire as viewed in the axial direction from rear;

FIG. 26 is a perspective explanatory view illustrating mating surfaces of the gear case and the motor bracket; and

FIG. 27 is an arrow view of a front surface of the motor bracket as viewed in the axial direction from front.

### DETAILED DESCRIPTION OF PREFERRED EMBODIMENTS

In one or more embodiments, a power tool may include a motor, an output part, a speed reducing mechanism, a gear case, a motor bracket, a switching operation part, and a switching wire. The output part may be provided forward of the motor and configured to be driven by the motor. The speed reducing mechanism may be disposed between the motor and the output part and may have a gear shifting function. The gear case may include: a cylindrical part having at least one through hole penetrating therethrough in a radial direction; and a plurality of bracket boss parts provided on an outer circumference of the cylindrical part, and may house the speed reducing mechanism inside the cylindrical part. The motor bracket may be disposed between the motor and the speed reducing mechanism and may be fixed to the bracket boss parts by the screws. The switching operation part may be configured to cause the speed reducing mechanism to change gear shifting by being moved. The switching wire may pass through the through hole of the gear case and may couple the switching operation part with the speed reducing mechanism. The switching wire may include at least one wire portion including first to third wire segments. The first wire segment may extend from the switching operation part to the cylindrical part as viewed from the axial direction. The second wire segment may extend in a circumferential direction along an outer circumferential surface of the cylindrical part from an end of the first wire segment. The third wire segment may extend from an end of the second wire segment and may be inserted into the through hole. The bracket boss parts are provided at positions other than a first region facing the second wire segment in the radial direction, on the outer circumference of the cylindrical part.

In the above-described configuration, the bracket boss parts of the gear case are provided at the positions other than the first regions facing the second wire segment in the radial direction, on the outer circumference of the cylindrical part. If the bracket boss parts are provided in the first region, the second wire segment of the switching wire go around the outside of the bracket boss part. In contrast, in the present configuration, the second wire segment of the switching wire connect the first wire segment with the third wire segment without going around the outside of the bracket boss part. This can shorten the path length of the switching wire leading to the speed reducing mechanism, thereby increasing the spring constant (rigidity) of the switching wire. Increasing the spring constant of the switching wire makes the switching wire less likely to be easily bent, and enables a gear coupled via the switching wire to be supported even when reaction force acts on the gear. As a result, positional shift of a gear for gear shifting of the speed reducing mechanism is less likely to occur, whereby more reliable gear shifting is achieved.

In one or more embodiments, the at least one through hole may include two though holes provided on one side and another side in a lateral direction of the gear case. The at least one wire portion may include: a first wire portion, which is provided on the one side and is inserted into the through hole provided on the one side; and a second wire portion, which is provided on the one side and is inserted into the through hole provided on the other side. The bracket boss parts may include a first boss disposed between the first wire segment of the first wire portion and the first wire segment of the second wire portion.

In the above-described configuration, the first boss of the bracket boss part can be disposed by utilizing the space between the first wire portion and the second wire portion. Thus, installation space for the bracket boss part (first boss) can be secured without increasing the dimensions of the gear case and the motor bracket while shortening the path length of the switching wire.

In one or more embodiments, the switching operation part may be disposed upward of the gear case. The bracket boss parts may include at least one second boss disposed in the second region located below the through holes on the outer circumference of the cylindrical part.

In the above-described configuration, by arranging the second boss in the second region located below the through holes where the switching wire is not disposed within the gear case, the number of fixing locations for the motor bracket can be increased without going diverting the path of the switching wire. The gear case and the motor bracket can be firmly fixed to each other by the first boss and the second boss. Thus, leakage of lubricant (grease) and the like can be suppressed, for example.

In one or more embodiments, at least one second boss may include two second bosses disposed on one side and the other side in the lateral direction of the cylindrical part in the second region.

In the above-described configuration, by arranging multiple (at least two) second bosses in the second region where the switching wire is not positioned within the gear case, multiple (at least two) fixing locations for the motor bracket to the gear case can be distributed over a wider circumferential range. As a result, the first boss and the multiple second bosses can fix the motor bracket more evenly. Even in the case, the switching wire does not need to go around the outside of bosses, and reliability of gear shifting can be enhanced.

In one or more embodiments, a radial distance between the second wire segment of the switching wire and an outer circumferential surface of the cylindrical part in the first region may be smaller than a protrusion amount of the bracket boss part with respect to the outer circumferential surface in the first region.

In the above-described configuration, the second wire segment of the switching wire is disposed radially inside the outer circumferential portion of the bracket boss part, and the distance between the second wire segment of the switching wire and the outer circumferential surface of the cylindrical part of the gear case is sufficiently decreased. This can effectively shorten the path length of the second wire segment of the switching wire. Therefore, the spring constant of the switching wire can be effectively increased to further improve the performance of holding the position of the gear for gear shifting.

In one or more embodiments, the power tool may further include a gear housing, which is provided forward of the gear case and to which a front end of the gear case is fixed. The gear case may include a plurality of housing boss parts, which is disposed radially outside the switching wire and is fixed to the gear housing by the screws.

In the above-described configuration, the gear case can be fixed to the gear housing by the plurality of housing boss parts separately from the bracket boss parts. Also in the case, the plurality of housing boss parts is disposed radially outside the switching wire. Thus, the switching wire does not need to go around the outside of the housing boss parts, and an increase in the path length of the switching wire can be avoided.

In one or more embodiments, the housing boss parts may include at least one third bosses disposed radially outside the second wire segment of the switching wire in the first region.

In the above-described configuration, in the first region where the bracket boss parts are not disposed, arrangement space for the housing boss parts (third boss) can be secured without diverting the second wire segment of the switching wire.

In one or more embodiments, the third bosses may have a cutout portion on an outer circumferential portion thereof facing the radial center of the cylindrical part, to prevent the switching wire from coming in contac with the third boss.

In the above-described configuration, the cutout portion is provided in the third boss disposed radially outside the second wire segment of the switching wire. With this, the radial position of the third boss can be brought closer to the second wire segment. This can inhibit an increase in the dimension of the outer shape of the gear case even having a configuration in which the third boss is disposed outside the second wire segment of the switching wire.

In one or more embodiments, the at least one through hole may include two through holes provided on one side and another side in a lateral direction of the gear case. The at least one wire portion may include: a first wire portion, which is disposed on the one side and is inserted into the through hole provided on one side; and a second wire portion, which is disposed on the other side and is inserted into the through hole provided on the other side. The at least one third boss may include two third bosses disposed on the outside of the second wire segment of the first wire portion and the outside of the second wire segment of the second wire portion.

In the above-described configuration, the third bosses are disposed on the outside of the second wire segment of the first wire portion and the outside of the second wire segment of the second wire portion. Thus, the fixing locations of the gear case and the gear housing can be distributed over a wider range. This enables the gear case to be fixed more evenly.

In one or more embodiments, the switching operation part may be disposed upward of the gear case. The housing boss parts may include a fourth boss disposed in the second region located below the through hole on the outer circumference of the cylindrical part.

In the above-described configuration, by arranging the fourth boss in the second region where the switching wire is not positioned within the gear case, a plurality of fixing locations for the gear case to the gear housing can be distributed over a wider circumferential range. As a result, the third bosses and the fourth boss can fix the gear case more evenly.

In one or more embodiments, a power tool may include a motor, an output part, a speed reducing mechanism, a gear case, a motor bracket, a switching operation part, and a switching wire. The output part may be provided forward of the motor and configured to be driven by the motor. The speed reducing mechanism may be disposed between the motor and the output part and may have a gear shifting function. The gear case may include a cylindrical part having at least one through hole penetrating therethrough in a radial direction and may house the speed reducing mechanism inside the cylindrical part. The motor bracket may be disposed between the motor and the speed reducing mechanism and may be fixed to the gear case by screw. The switching operation part may be configured to cause the speed reducing mechanism to change gear shifting by being moved. The switching wire may pass through the through hole of the gear case and may couple the switching operation part with the speed reducing mechanism. The switching wire may include a held portion held by the switching operation part. The gear case may include a first screw fixing part, which is provided at a position facing the held portion of the switching wire in the radial direction as viewed from the axial direction and fixes the motor bracket.

In the above-described configuration, in the gear case, the first screw fixing part for fixing the motor bracket is disposed at a position facing the held portion of the switching wire in the radial direction as viewed from the axial direction. If the first screw fixing part is provided in the middle of a path to the speed reducing mechanism, the switching wire goes around the outside of the first screw fixing part. In contrast, in the configuration, the switching wire can be connected to a coupling portion with the speed reducing mechanism without going around the outside of the first screw fixing part from the held portion. This can shorten the path length of the switching wire leading to the speed reducing mechanism of the switching wire, thereby increasing the spring constant (rigidity) of the switching wire. Increasing the spring constant of the switching wire makes the switching wire less likely to be easily bent, and enables a gear coupled via the switching wire to be supported even when reaction force acts on the gears. As a result, positional shift of a gear for gear shifting of the speed reducing mechanism is less likely to occur, whereby more reliable gear shifting is achieved.

In one or more embodiments, in the gear case, the first screw fixing part may be provided at one location in a facing region facing the switching wire in the radial direction as viewed from the axial direction. In the gear case, a plurality of second screw fixing parts, which fixes the motor bracket, may be provided in a non-facing region not facing the switching wire in the radial direction as viewed from the axial direction.

In the above-described configuration, only one first screw fixing part is provided in the facing region, whereby the switching wire does not need to go around the screw fixing parts. The plurality of second screw fixing parts is provided in the non-facing region, whereby the motor bracket and the gear case can be evenly fixed to each other at a plurality of locations while avoiding an increase in the path length of the switching wire.

In one or more embodiments, the gear case and the motor bracket may be fixed to each other at three locations arranged in a triangular shape as viewed from the axial direction, by one first screw fixing part disposed in the facing region and two second screw fixing parts disposed on one side and another side in the lateral direction with respect to the center of the gear case in the non-facing region.

In the above-described configuration, by fixing the motor bracket and the gear case at the three locations disposed in the triangular shape as viewed from the axial direction, the motor bracket and the gear case can be evenly and firmly fixed to each other while avoiding an increase in the path length of the switching wire.

In one or more embodiments, the gear case may have a first mating surface having an annular flat shape on a rear end surface facing the motor bracket. The motor bracket may have a second mating surface having an annular flat shape, which in in contact with the first mating surface, on a front surface facing the gear case.

In the above-described configuration, the first mating surface of the gear case and the second mating surface of the motor bracket both having a flat surface can be brought into surface contact with each other. This can effectively inhibit leakage of lubricant (grease) inside the gear case and the like even when vibration caused by driving of the motor is generated.

In one or more embodiments, the power tool may further include a gear housing, which is provided forward of the gear case and to which a front end of the gear case is fixed. The gear case may include two third screw fixing parts disposed at a position in a circumferential direction between the first screw fixing part and the second screw fixing part disposed on the one side and a position in the circumferential direction between the first screw fixing part and the second screw fixing part disposed on the other side.

In the above-described configuration, screw tightening locations (third screw fixing parts) where the gear case and the gear housing are screw-tightened can be disposed at positions shifted in the circumferential direction with respect to the screw tightening locations (first screw fixing part and second screw fixing parts) where the gear case and the motor bracket are screw-tightened. This can improve workability of screw tightening work.

In one or more embodiments, the gear case may include one fourth screw fixing part disposed between the two second screw fixing parts disposed on the one side and the other side in the non-facing region. The gear case and the gear housing may be fixed to each other at three locations arranged in an inverted triangular shape as viewed from the axial direction, by the two third screw fixing parts and the one fourth screw fixing part.

In the above-described configuration, the motor bracket and the gear case are fixed to each other at three locations disposed in the triangular shape as viewed from the axial direction. The gear case and the gear housing are fixed to each other at three locations disposed in the inverted triangular shape as viewed from the axial direction. Thus, the fixation of the motor bracket with the gear case and fixation of the gear case with the gear housing can be evenly performed, and the workability of screw tightening work for each fixation can be improved.

An embodiment according to the present disclosure will be described below with reference to the drawings; however, the present disclosure is not limited thereto. Components of the embodiment to be described below can be appropriately combined. Furthermore, some components are not used in some cases.

In the embodiment, positional relationships among the parts will be described using the terms left, right, front, rear, up, and down. These terms indicate relative position or direction with respect to the center of a power tool.

The power tool includes a motor. In the embodiment, the direction parallel to a rotation axis AX of the motor is appropriately referred to as the axial direction. The direction going around the rotation axis AX is appropriately referred to as the circumferential direction or the rotational direction. The radial direction of the rotation axis AX is appropriately referred to as the radial direction.

In the embodiment, rotational axis AX extends in a front-rear direction of the power tool. The axial direction and the front-rear direction coincide (are colinear) or are parallel with each other. One side in the axial direction is forward, and the other side in the axial direction is rearward. In addition, in the radial direction, a location that is proximate to or a direction that approaches rotational axis AX is called “radially inward” where appropriate, and a location that is distant from or a direction that leads away from rotational axis AX is called “radially outward” where appropriate.

### Overview of Power Tool

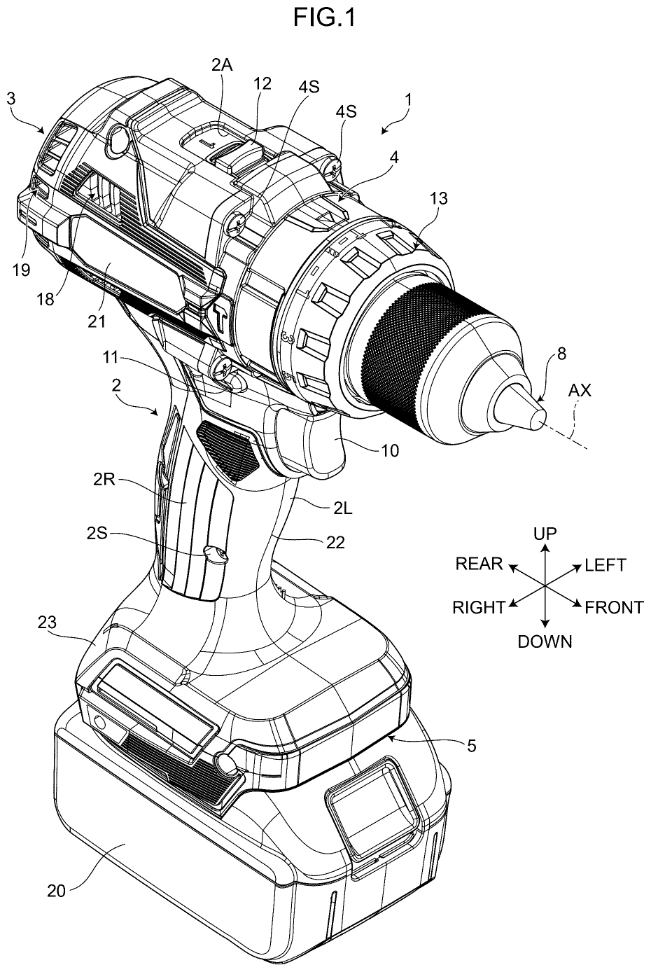

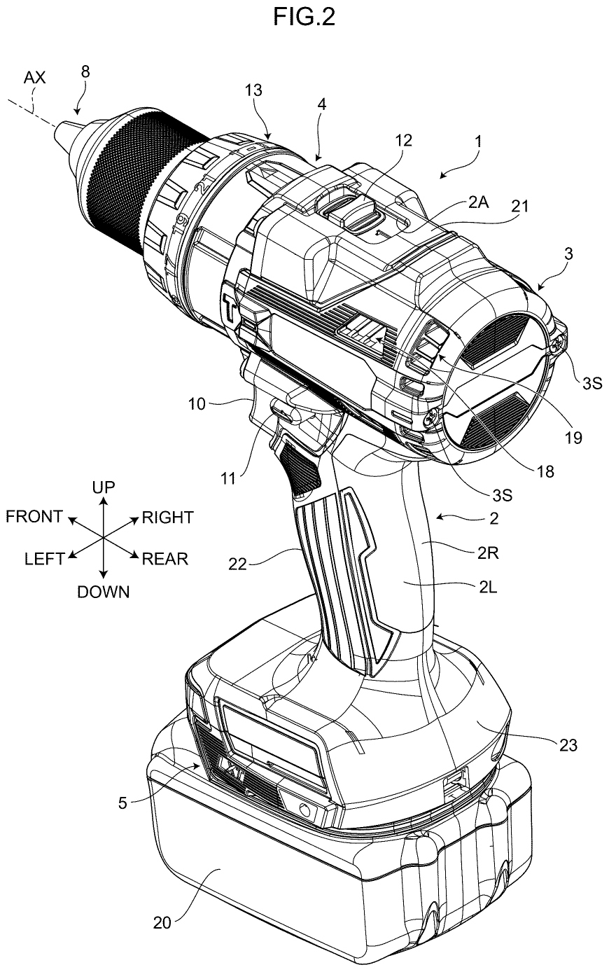

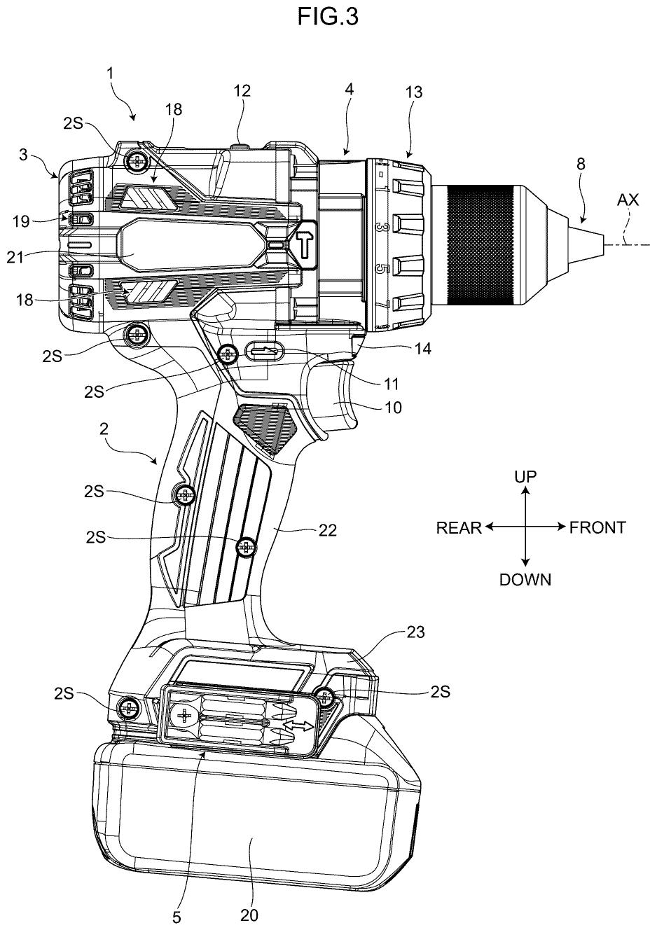

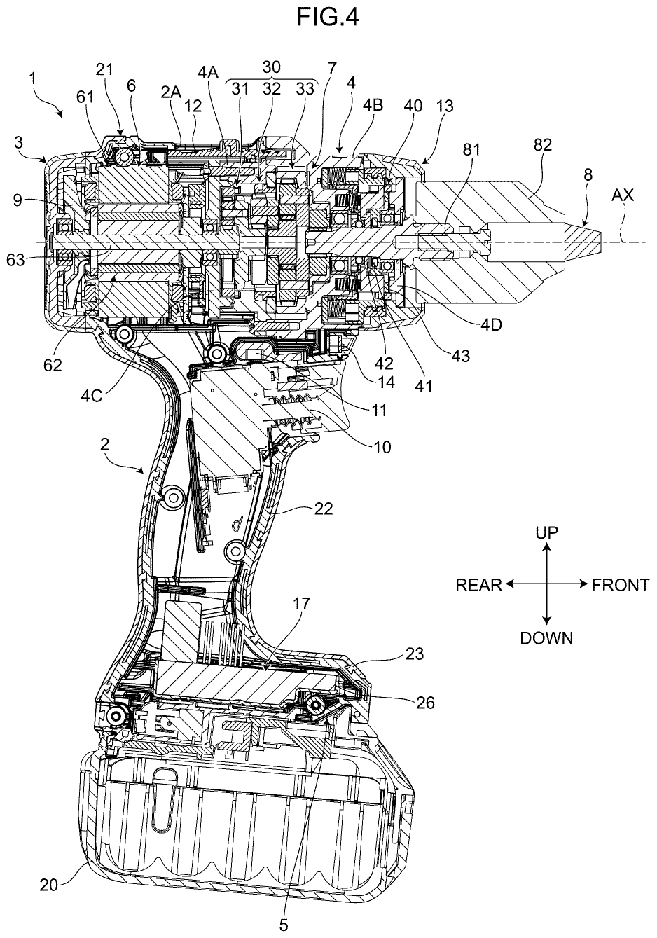

FIG. 1 is a perspective view illustrating a power tool 1 according to the embodiment as viewed from front. FIG. 2 is a perspective view illustrating the power tool 1 according to the embodiment as viewed from rear. FIG. 3 is a side view illustrating the power tool 1 according to the embodiment. FIG. 4 is a cross-sectional view illustrating the power tool 1 according to the embodiment. In the embodiment, the power tool 1 is a hammer driver drill.

As illustrated in FIGS. 1 to 4, the power tool 1 includes a housing 2, a rear cover 3, a casing 4, a battery mounting part 5, a motor 6, a power transmission mechanism 7, an output part 8, a fan 9, a trigger lever 10, a forward/reverse rotation switching lever 11, a speed changing lever 12, a mode changing ring 13, a light 14, and a controller 17. The speed changing lever 12 is one example of a switching operation part.

The housing 2 is made of synthetic resin. In the embodiment, the housing 2 is preferably made of nylon. The housing 2 includes a left housing 2L and a right housing 2R. The left housing 2L and the right housing 2R are fixed by screws 2S. The left housing 2L and the right housing 2R are fixed to form the housing 2.

The housing 2 includes a motor housing part 21, a grip part 22, and a battery holding part 23.

The motor housing part 21 houses the motor 6. The motor housing part 21 has a tubular shape. The motor housing part 21 is disposed so as to cover the periphery of the motor 6.

The grip part 22 is gripped by a user. The grip part 22 is disposed downward of the motor housing part 21. The grip part 22 extends downward from the motor housing part 21. The trigger lever 10 is disposed at a front portion of the grip part 22.

The battery holding part 23 houses the controller 17. The battery holding part 23 is disposed at a lower portion of the grip part 22. The battery holding part 23 is connected to a lower end portion of the grip part 22. In both the front-rear direction and a left-right direction, the battery holding part 23 has an outer shape dimension larger than that of the grip part 22.

The rear cover 3 is made of synthetic resin. The rear cover 3 is disposed rearward of the motor housing part 21. The rear cover 3 is disposed so as to cover a rear portion of the motor 6. The rear cover 3 houses the fan 9. The rear cover 3 is disposed so as to cover an opening in a rear portion of the motor housing part 21. The rear cover 3 is fixed to the motor housing part 21 by screws 3S.

The motor housing part 21 has air intake ports 18. The rear cover 3 has air exhaust ports 19. Air that is outside of the housing 2 flows into the interior space of the housing 2 via the air intake ports 18. Air in the interior space of the housing 2 flows out to the exterior of the housing 2 via the air exhaust ports 19.

The casing 4 houses the power transmission mechanism 7. The casing 4 includes a gear case 4A, a gear housing 4B, a motor bracket 4C, and a stop plate 4D. The gear housing 4B is provided forward of the gear case 4A. The mode changing ring 13 is disposed forward of the gear housing 4B. The gear case 4A is made of synthetic resin. The gear housing 4B is made of metal. In the embodiment, the gear housing 4B is made of aluminum. The casing 4 is connected to a front portion of the motor housing part 21. Each of the gear case 4A and the gear housing 4B has a tubular shape.

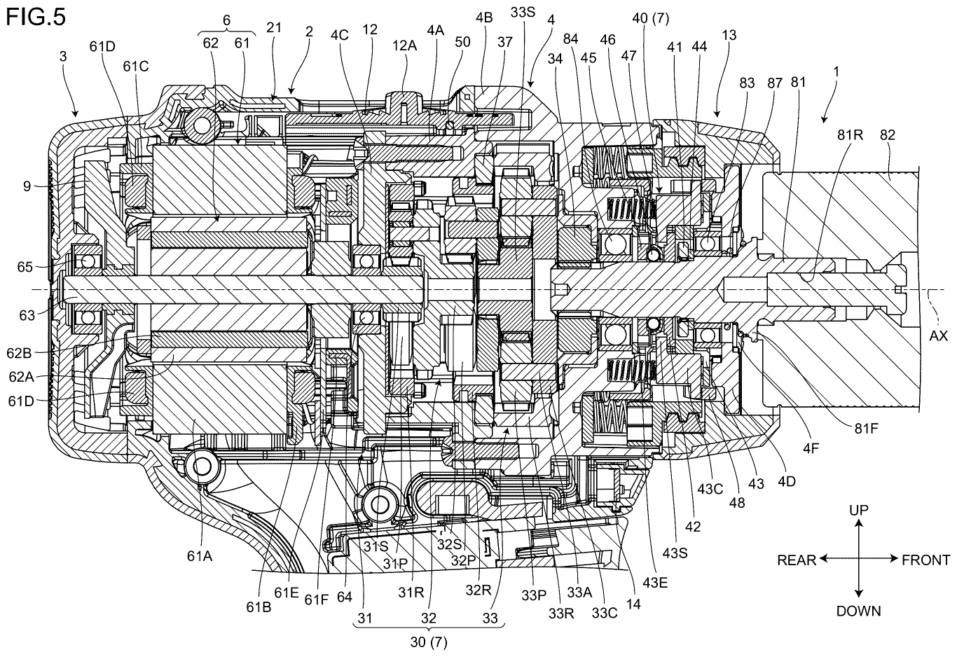

A front end of the gear case 4A is fixed to the gear housing 4B. The gear case 4A is fixed to a rear end portion of the gear housing 4B. The motor bracket 4C is made of synthetic resin. The motor bracket 4C is disposed so as to cover an opening at a rear end portion of the gear case 4A. The motor bracket 4C is fixed to the rear end portion of the gear case 4A. The stop plate 4D is disposed so as to cover an opening at a front end of the gear housing 4B. The stop plate 4D is fixed to the front end portion of the gear housing 4B by screws 4F (see FIG. 5).

The casing 4 is disposed so as to cover an opening in the front portion of the motor housing part 21. The gear case 4A is disposed inside the motor housing part 21. The gear housing 4B is fixed to the motor housing part 21 by screws 4S.

The battery mounting part 5 is formed at a lower portion of the battery holding part 23. The battery mounting part 5 is connected to a battery pack 20. The battery pack 20 is mounted on the battery mounting part 5. The battery pack 20 is detachable from the battery mounting part 5. The battery pack 20 includes a secondary (rechargeable) battery. In the embodiment, the battery pack 20 includes a rechargeable lithium-ion battery. When mounted on the battery mounting part 5, the battery pack 20 can supply power to the power tool 1. The motor 6 is driven by the electric power supplied from the battery pack 20. The controller 17 operate using electric power supplied from the battery pack 20.

The motor 6 is a power supply of the power tool 1. The motor 6 is an inner rotor type brushless motor. The motor 6 is housed in the motor housing part 21. The motor 6 includes a tubular stator 61 and a rotor 62 disposed inside the stator 61. The rotor 62 rotates with respect to the stator 61. The rotor 62 includes a rotor shaft 63 extending in the axial direction.

The power transmission mechanism 7 is disposed forward of the motor 6. The power transmission mechanism 7 is housed in the casing 4. The power transmission mechanism 7 operably couples the rotor shaft 63 and the output part 8 to each other. The power transmission mechanism 7 transmits power generated by the motor 6 to the output part 8. The power transmission mechanism 7 includes a plurality of gears.

The power transmission mechanism 7 includes a speed reducing mechanism 30 and a hammer mechanism 40.

The speed reducing mechanism 30 is disposed between the motor 6 and the output part 8. The speed reducing mechanism 30 is driven by the rotor 62 (the rotor shaft 63) and causes the output part 8 to rotate at a rotational speed lower than the rotational speed of the rotor 62 (but higher torque). The speed reducing mechanism 30 can shift gears (i.e., can change the speed reduction ratio). The speed reducing mechanism 30 includes a gear mechanism connected to the speed changing lever 12. The reduction ratio of the speed reducing mechanism 30 is switched by changing an intermeshing position of the gear mechanism in accordance with the speed change position of the speed changing lever 12,. In the embodiment, the speed reducing mechanism 30 includes a first (first stage) planetary gear mechanism 31, a second (second stage) planetary gear mechanism 32, and a third (third stage) planetary gear mechanism 33. At least a portion of the first planetary gear mechanism 31 is disposed forward of the motor 6. The second planetary gear mechanism 32 is disposed forward of the first planetary gear mechanism 31. The third planetary gear mechanism 33 is disposed forward of the second planetary gear mechanism 32. The first planetary gear mechanism 31 is driven (operated) by rotational force output by the motor 6 via the rotor shaft 63. The second planetary gear mechanism 32 is driven (operated) by rotational force output by the first planetary gear mechanism 31. The third planetary gear mechanism 33 is driven (operated) by rotational force output by the second planetary gear mechanism 32.

The hammer mechanism 40, when actuated, causes the output part 8 to hammer in the axial direction. The hammer mechanism 40 includes a first cam 41, a second cam 42, and a hammer switching ring 43.

The output part 8 is disposed forward of the motor 6. The output part 8 is rotated using the rotational force output by the motor 6. That is, the output part 8 is rotated using the rotational force output by the rotor 62. More specifically, the output part 8 is rotated, in the state in which a tool accessary has been attached thereto, by rotational force output from the rotor 62 and transmitted via the power transmission mechanism 7. The output part 8 includes a spindle 81 and a chuck 82. The spindle 81 is rotatable about the rotation axis AX by the rotational force transmitted from the rotor 62. The chuck 82 is attached to the spindle 81 and is configured to hold a tool accessary. That is, the tool accessory is held by the chuck 82. A front end portion of the chuck 82 is disposed forward of the casing 4. At least a portion of the spindle 81 is disposed forward of the third planetary gear mechanism 33. The spindle 81 is operably coupled to the third planetary gear mechanism 33. The spindle 81 is rotated by the rotational force output by the rotor 62 and transmitted via the first planetary gear mechanism 31, the second planetary gear mechanism 32, and the third planetary gear mechanism 33.

The fan 9 is disposed rearward of the motor 6. The fan 9 generates an airflow for cooling the motor 6. The fan 9 is fixed to at least a portion of the rotor 62. More specifically, the fan 9 is fixed to a rear portion of the rotor shaft 63. The fan is rotated by the rotation of the rotor shaft 63. That is, the rotor shaft 63 rotates, the fan 9 rotates together with the rotor shaft 63. When the fan 9 rotates, air outside of the housing 2 flows into the interior space of the housing 2 via the air intake ports 18. The air that has flowed into the interior space of the housing 2 flows through the interior space of the housing 2, and thereby cools the motor 6. The air that has flowed through the interior space of the housing 2 flows out to the exterior of the housing 2 via the air exhaust ports 19.

The trigger lever 10 is operated to start the motor 6. The trigger lever 10 is provided at an upper portion of the grip part 22. A front end portion of the trigger lever 10 protrudes forward from a front portion of the grip part 22. The trigger lever 10 is movable in the front-rear direction. The trigger lever 10 is configured to be operated by the user. By operating (pressing) the trigger lever 10 such that it moves rearward, the motor 6 starts. By releasing the trigger lever 10, the motor 6 stops.

The forward/reverse rotation switching lever 11 is operated (slid) to change the rotational direction of the motor 6. The forward/reverse rotation switching lever 11 is provided at an upper portion of the grip part 22. A left end portion of the forward/reverse rotation switching lever 11 protrudes leftward from a left portion of the grip part 22. A right end portion of the forward/reverse rotation switching lever 11 protrudes rightward from a right portion of the grip part 22. The forward/reverse rotation switching lever 11 is movable in the left-right direction. The forward/reverse rotation switching lever 11 is configured to be operated by the user. By operating (sliding) the forward/reverse rotation switching lever 11 such that it moves leftward, the motor 6 rotates in a forward rotational direction. By operating (sliding) the forward/reverse rotation switching lever 11 such that it moves rightward, the motor 6 rotates in a reverse rotational direction. By changing the rotational direction of the motor 6, the rotational direction of the spindle 81 changes.

The speed changing lever 12 is a switching operation part that is configured to be operated to change (switch) the speed mode (gear shift stage) of the speed reducing mechanism 30. The speed changing lever 12 is provided at an upper portion of the motor housing part 21. The speed changing lever 12 is provided upward of the casing 4. The speed changing lever 12 is configured to cause the speed reducing mechanism 30 to change gear shifting (i.e., change the speed mode or change a reduction ratio of the speed changing lever 12). The speed changing lever 12 is operated (moved, slid) by the user. The speed changing lever 12 is movable in the front-rear direction. The speed modes of the speed reducing mechanism 30 include a low-speed mode (speed “1”) and a high-speed mode (speed “2”). That is, in the embodiment, the speed reducing mechanism 30 can change gear shifting in two stages. The low-speed mode refers to a speed mode in which the output part 8 is caused to rotate at a first rotational speed (low speed) while the rotor 62 is rotating at a constant rotational speed. The high-speed mode refers to a speed mode in which the output part 8 is caused to rotate at a second rotational speed (high speed) higher than the first rotational speed while the rotor 62 is rotating at the same constant rotational speed.

The mode changing ring 13 is configured to be operated (rotated) to change the action mode of the hammer mechanism 40. The mode changing ring 13 is disposed forward of the casing 4. The mode changing ring 13 is rotatable. More specifically, the mode changing ring 13 is configured to be operated (manually rotated) by the user. The action modes of the hammer mechanism 40 include a hammer mode and a non-hammer mode. The hammer mode refers to an action mode in which the output part 8 is caused to hammer in the axial direction. The non-hammer mode refers to an action mode in which the output part 8 is not caused to hammer in the axial direction. By operating (rotating) the mode changing ring 13 such that it is disposed at a hammer mode position in the rotational direction, the action mode of the hammer mechanism 40 is set to the hammer mode. By operating (rotating) the mode changing ring 13 such that it is disposed at a non-hammer mode position in the rotational direction, the action mode of the hammer mechanism 40 is set to the non-hammer mode.

The light 14 emits illumination light that illuminates the front of the power tool 1. The light 14 includes, for example, a light emitting diode (LED). The light 14 is disposed in a lower portion of the front portion of the motor housing part 21. The light 14 is disposed upward of the trigger lever 10.

The controller 17 includes a computer system. The controller 17 outputs control commands to control the motor 6. At least a portion of the controller 17 is housed in a controller case 26. The controller 17 is housed in the battery holding part 23 with the controller 17 being held by (in) the controller case 26. The controller 17 preferably includes a circuit board on which a plurality of electronic parts is mounted. Examples of the electronic parts mounted on the circuit board include a processor such as a central processing unit (CPU), a nonvolatile memory such as a read only memory (ROM) and a storage, a volatile memory such as a random access memory (RAM), a transistor, capacitor, and a resistor.

### Motor and Power Transmission Mechanism

FIG. 5 is a cross-sectional view illustrating a part of the power tool 1 according to the embodiment. As illustrated in FIG. 5, the motor 6 includes: the stator 61, which has a tubular shape; and the rotor 62, which is disposed inside the stator 61. The rotor 62 includes the rotor shaft 63 extending in the axial direction.

The stator 61 includes a stator core 61A, a front insulator 61B, a rear insulator 61C, a plurality of coils 61D, a sensor circuit board 61E, and a short-circuit member 61F. The stator core 61A includes a plurality of stacked (laminated) steel sheets. The front insulator 61B is disposed at a front portion of the stator core 61A. The rear insulator 61C is disposed at a rear portion of the stator core 61A. The coils 61D are respectively wound around teeth disposed on inner surface of the stator core 61A and over the front insulator 61B and the rear insulator 61C. The sensor circuit board 61E is mounted on the front insulator 61B. The short-circuit member 61F is supported on the front insulator 61B. The sensor circuit board 61E includes a plurality of rotation detecting elements that detect rotation of the rotor 62. The short-circuit member 61F electrically connects respective pairs of the coils 61D via fusing terminals. The short-circuit member 61F is electrically connected to the controller 17 via lead wires.

The rotor 62 rotates about rotation axis AX. The rotor 62 includes the rotor shaft 63, a rotor core 62A, and a plurality of permanent magnets 62B. The rotor core 62A is disposed around the rotor shaft 63. The permanent magnets 62B are held on or in the rotor core 62A. The rotor core 62A has a circular tube shape. The rotor core 62A includes a plurality of stacked (laminated) steel sheets. The rotor core 62A has through holes extending in the axial direction. The through holes are arranged in (around) the circumferential direction of the rotor core 62A. The permanent magnets 62B are respectively disposed in the through holes of the rotor core 62A.

The rotation detecting elements of the sensor circuit board 61E detect rotation (rotational position) of the rotor 62 by detecting the magnetic fields of the permanent magnets 62B. The controller 17 supplies drive currents to the respective coils 61D based on detection data from the rotation detecting elements.

The rotor shaft 63 rotates about the rotation axis AX. The rotation axis AX of the rotor shaft 63 coincides with the rotation axis of the output part 8. A front portion of the rotor shaft 63 is rotatably supported by a bearing 64. A rear portion of the rotor shaft 63 is rotatably supported by a bearing 65. The bearing 64 is held by the motor bracket 4C, which is disposed forward of the stator 61. The motor bracket 4C supports the front portion of the rotor shaft 63 via the bearing 64. The bearing 65 is held by the rear cover 3. A front end portion of the rotor shaft 63 is disposed forward of the bearing 64. The front end portion of the rotor shaft 63 passes through the motor bracket 4C, and is disposed in (extends into) the interior space of the gear case 4A. The motor bracket 4C is disposed between the motor 6 and the speed reducing mechanism 30.

A pinion gear 31S is provided at (on) the front end portion of the rotor shaft 63. The pinion gear 31S functions as a sun gear of the first planetary gear mechanism 31. The pinion gear 31S is rotated by the motor 6. The rotor shaft 63 is operably coupled to the first planetary gear mechanism 31 of the speed reducing mechanism 30 via the pinion gear 31S.

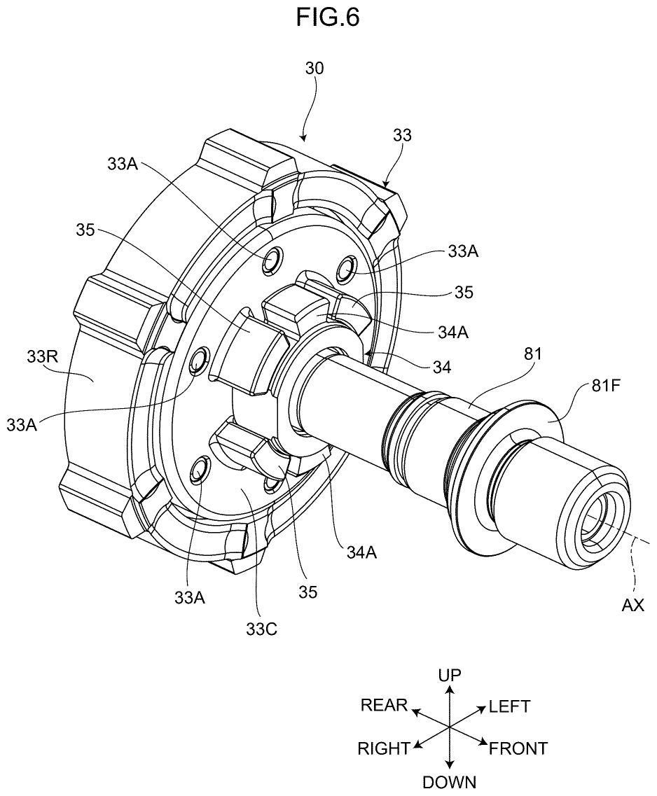

FIG. 6 is a perspective view illustrating a part of the speed reducing mechanism 30 according to the embodiment as viewed from right front. The spindle 81 is coupled to a third carrier 33C. In the embodiment, an engaging member 34 is provided on an outer circumferential surface of the spindle 81. The engaging member 34 is fixed to the spindle 81. The engaging member 34 includes protrusions 34A protruding in opposite directions from an outer circumferential portion of the engaging member 34. The third carrier 33C is disposed around the spindle 81. Engaging projections 35 are provided on the front surface of the third carrier 33C. The engaging projections 35 protrude forward. The engaging projections 35 come in contact with the protrusions 34A of the engaging member 34 in the circumferential direction. Relative rotation between the third carrier 33C and the spindle 81 is blocked by the contact between the engaging projections 35 and the protrusions 34A of the engaging member 34. Thus, when the third carrier 33C rotates, the spindle 81 rotates together with the third carrier 33C.

The spindle 81 is rotatably supported by a bearing 83 and a bearing 84. In the state in which the spindle 81 is supported by the bearing 83 and the bearing 84, the spindle 81 is movable in the front-rear direction.

As illustrated in FIG. 5, the spindle 81 includes a flange portion 81F. A coil spring 87 is disposed between the flange portion 81F and the bearing 83. The flange portion 81F comes in contact with a front end portion of the coil spring 87. The coil spring 87 generates elastic force that urges (biases) the spindle 81 forward.

The chuck 82 is configured to hold the tool accessary. The chuck 82 is coupled to a front portion of the spindle 81. A screw hole 81R is provided at a front end portion of the spindle 81. When the spindle 81 rotates, the chuck 82 rotates therewith. The chuck 82 is rotatable in the state in which the chuck 82 holds the tool accessary.

The first cam 41 and the second cam 42 of the hammer mechanism 40 are both disposed inside the gear housing 4B. In the front-rear direction, both the first cam 41 and the second cam 42 are disposed between the bearing 83 and the bearing 84.

The first cam 41 has a ring shape. The first cam 41 is disposed around the spindle 81. The first cam 41 is fixed to the spindle 81. The first cam 41 rotates together with the spindle 81. Cam teeth are provided on the rear surface of the first cam 41. The first cam 41 is supported by a stop ring 44. The stop ring 44 is disposed around the spindle 81. The stop ring 44 is disposed between the first cam 41 and the bearing 83 in the front-rear direction.

The second cam 42 also has a ring shape. The second cam 42 is disposed rearward of the first cam 41. The second cam 42 is disposed around the spindle 81. The second cam 42 is rotatable relative to the spindle 81. Cam teeth are provided on the front surface of the second cam 42. The cam teeth on the front surface of the second cam 42 mesh with the cam teeth on the rear surface of the first cam 41. A tab is provided on the rear surface of the second cam 42.

A support ring 45 is disposed between the second cam 42 and the bearing 84 in the front-rear direction. The support ring 45 is disposed inside the gear housing 4B. The support ring 45 is fixed to the gear housing 4B. A plurality of steel balls 46 is disposed on the front surface of the support ring 45. A washer 47 is disposed between the steel balls 46 and the second cam 42. The second cam 42 is rotatable in the state in which forward-rearward movement thereof is restricted to (within) a space defined by the support ring 45 and the washer 47.

The hammer switching ring 43 is switchable from the hammer mode to the non-hammer mode and vice versa by manually rotating it. The mode changing ring 13 is coupled to the hammer switching ring 43 via a cam ring 48. The mode changing ring 13 and the cam ring 48 can integrally rotatable. The hammer switching ring 43 holds a switching cam 43C such that the switching cam 43C is movable in the front-rear direction. The hammer switching ring 43 is inserted into a guide hole provided in the gear housing 4B. Rotation of the hammer switching ring 43 is constrained by a guide groove provided in the gear housing 4B. The switching cam 43C is biased forward by a spring 43E that is held by (in) the gear housing 4B. When the user operates (manually rotates) the mode changing ring 13 in a predetermined direction, the switching cam 43C is pushed by the mode changing ring 13 and moves rearward. When the user operates (manually rotates) the mode changing ring 13 in the opposite direction, the switching cam 43C is pushed by the spring 43E and returns to its forward position. When the switching cam 43C moves in the front-rear direction between an advanced (forward) position and a retracted (rearward) position, the action mode correspondingly changes between the hammer mode and the non-hammer mode. Thus, manual rotation of the mode changing ring 13 causes the action mode to change from the hammer mode to the non-hammer mode and vice versa.

The hammer mode includes the state in which rotation of the second cam 42 is blocked. The non-hammer mode includes the state in which rotation of the second cam 42 is permitted. The rotation of the second cam 42 is blocked when the switching cam 43C has been moved to the advanced (forward) position. The rotation of the second cam 42 is permitted when the switching cam 43C has been moved to the retracted (rearward) position.

In the hammer mode, at least a portion of the switching cam 43C, which has moved to the advanced position, comes in contact with the second cam 42. The rotation of the second cam 42 is blocked owing to the contact between the switching cam 43C and the second cam 42. When the motor 6 is driven with rotation of the second cam 42 being blocked, the first cam 41, which is fixed to the spindle 81, rotates while making contact with the cam teeth of the second cam 42. This causes the spindle 81 to rotate while being hammered in the front-rear (axial) direction.

In the non-hammer mode, the switching cam 43C, which has been moved to the retracted position, is spaced apart from the second cam 42. Rotation of the second cam 42 is permitted owing to the switching cam 43C and the second cam 42 being spaced apart (i.e., in a non-contacting state). When the motor 6 is driven with rotation of the second cam 42 being permitted, the second cam 42 rotates together with the first cam 41 and the spindle 81. This causes the spindle 81 to rotate without being hammered in the front-rear (axial) direction.

The hammer switching ring 43 is disposed around the first cam 41 and the second cam 42. Furthermore, the switching cam 43C includes a facing portion 43S that faces the rear surface of the second cam 42. The facing portion 43S protrudes radially inward from a rear portion of the switching cam 43C.

When the mode changing ring 13 is operated (manually rotated) and the switching cam 43C is thereby moved to the advanced (forward) position, the tab on the rear surface of the second cam 42 comes in contact with the facing portion 43S of the switching cam 43C. Thereby, rotation of the second cam 42 is blocked. Thus, the hammer mechanism 40 is switched to the hammer mode because the switching cam 43C has been moved to the advanced position.

On the other hand, when the mode changing ring 13 is operated (manually rotated in the opposite direction) and the switching cam 43C has been moved to the retracted position, the facing portion 43S of the switching cam 43C is spaced apart from the second cam 42. Thereby, rotation of the second cam 42 is permitted. Thus, when the mode changing ring 13 is manually rotated and the switching cam 43C is thereby moved to the retracted position, the hammer mechanism 40 is switched to the non-hammer mode.

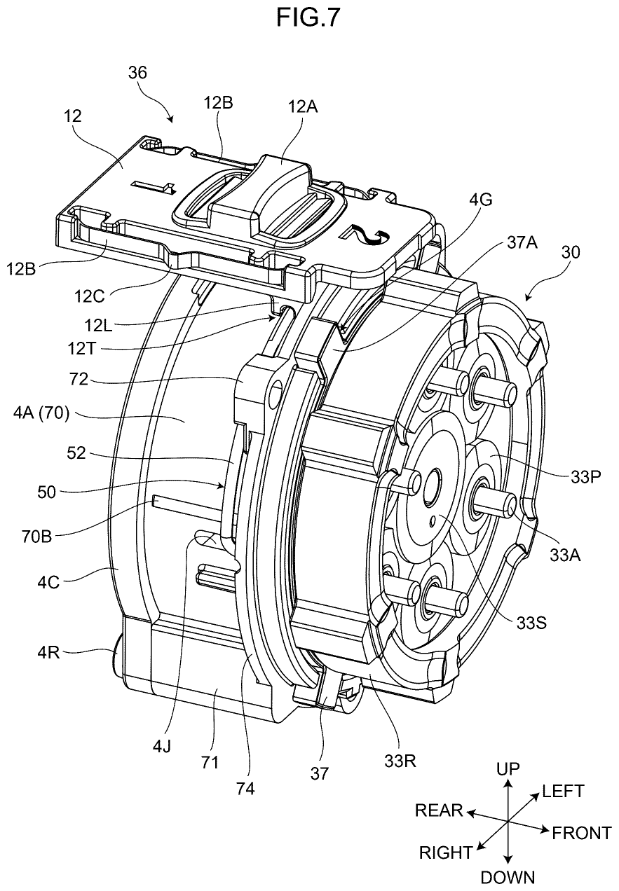

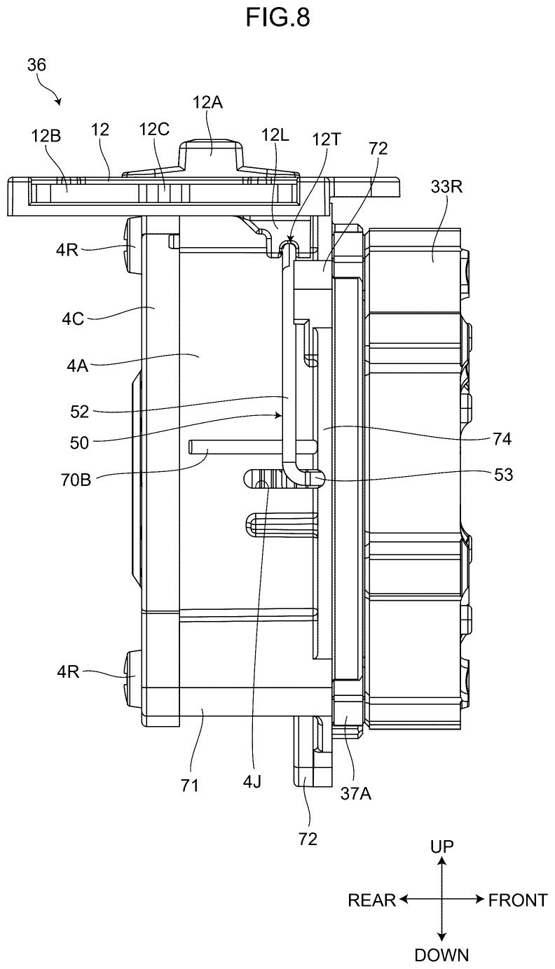

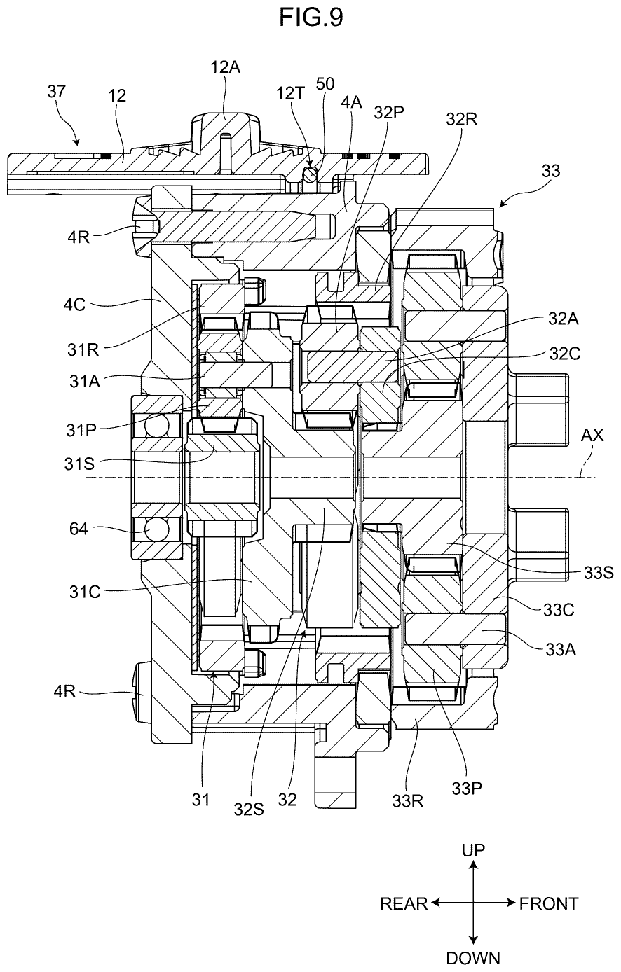

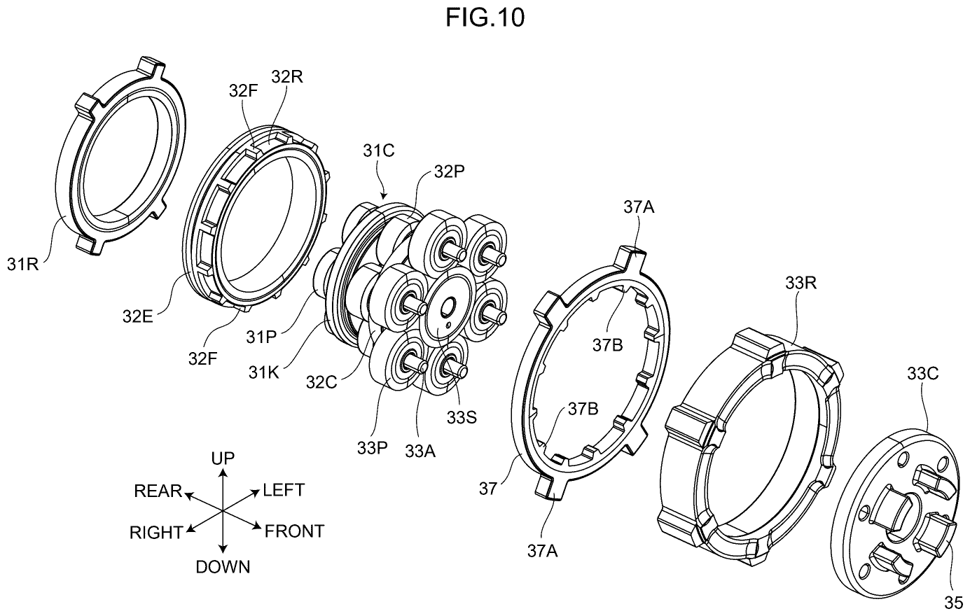

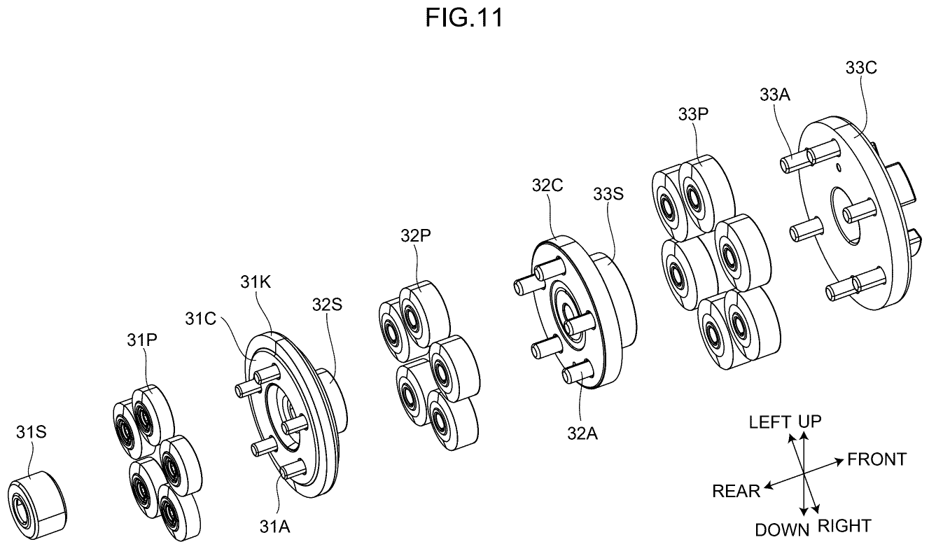

FIG. 7 is a perspective view illustrating a part of the power tool 1 according to the embodiment as viewed from front. FIG. 8 is a side view illustrating the part of the power tool 1 according to the embodiment. FIG. 9 is a cross-sectional view illustrating the part of the power tool 1 according to the embodiment. FIG. 10 is an exploded perspective view illustrating the speed reducing mechanism 30 according to the embodiment as viewed from front. FIG. 11 is a perspective view illustrating a part of the speed reducing mechanism 30 according to the embodiment as viewed from rear. Note that, in the drawings, illustration of the specific shape of teeth of gears that mesh with each other is omitted for simplification of the drawings.

The first planetary gear mechanism 31 includes a plurality of planetary gears 31P, a first carrier 31C, and an internal gear 31R. The first carrier 31C supports the plurality of planetary gears 31P. The internal gear 31R is disposed around the plurality of planetary gears 31P. The pinion gear 31S is provided at the front end portion of the rotor shaft 63 (see FIG. 5). The pinion gear 31S functions as a sun gear of the first planetary gear mechanism 31. The pinion gear 31S is disposed forward of the stator 61. The pinion gear 31S is rotated by the rotor 62. The pinion gear 31S may be rotated directly or indirectly by the rotor 62. The planetary gears 31P are disposed around the pinion gear 31S.

The second planetary gear mechanism 32 includes a sun gear 32S, a plurality of planetary gears 32P, a second carrier 32C, and an internal gear 32R. The planetary gears 32P are disposed around the sun gear 32S. The second carrier 32C supports the plurality of planetary gears 32P. The internal gear 32R is disposed around the plurality of planetary gears 32P. The sun gear 32S is disposed forward of the internal gear 31R. The sun gear 32S may be rotated directly or indirectly by the planetary gears 31P. The planetary gears 32P mesh with the sun gear 32S. The internal gear 32R meshes with the planetary gears 32P.

The third planetary gear mechanism 33 includes a sun gear 33S, a plurality of planetary gears 33P, the third carrier 33C, and an internal gear 33R. The planetary gears 33P are disposed around the sun gear 33S. The third carrier 33C supports the plurality of planetary gears 33P. The internal gear 33R is disposed around the plurality of planetary gears 33P.

The gear case 4A and the gear housing 4B are disposed forward of the stator 61. The gear case 4A houses the pinion gear 31S, the planetary gears 31P, the internal gear 31R, the first carrier 31C, the sun gear 32S, the planetary gears 32P, and the internal gear 32R. The gear housing 4B houses the second carrier 32C, the sun gear 33S, the planetary gears 33P, the internal gear 33R, a locking ring 37, and the third carrier 33C.

The planetary gears 31P are rotatably supported on first pins 31A, respectively. The first pins 31A are supported on the first carrier 31C. The first pins 31A protrude rearward from the rear surface of the first carrier 31C. The first pins 31A are arranged spaced apart in the circumferential direction. In the embodiment, five first pins 31A are disposed equispaced in the circumferential direction. The (five) planetary gears 31P are respectively supported on the (five) first pins 31A. The planetary gears 31P are disposed rearward of the first carrier 31C. The first carrier 31C supports the (five) planetary gears 31P in a rotatable manner via the respective (five) first pins 31A. An external tooth gear 31K is provided on the outer circumference of the first carrier 31C. The internal gear 31R is disposed around the plurality of planetary gears 31P.

The sun gear 32S is disposed forward of the first carrier 31C. The diameter of sun gear 32S is smaller than the diameter of the first carrier 31C. The first carrier 31C and the sun gear 32S rotate together. The first carrier 31C and the sun gear 32S may be integrated or separated (separate parts). Pins 32A are provided on the second carrier 32C. The planetary gears 32P are rotatably supported on the pins 32A, respectively. The second carrier 32C supports the planetary gears 32P via the respective pins 32A in a rotatable manner.

The sun gear 33S is disposed forward of the second carrier 32C. The diameter of the sun gear 33S is smaller than the diameter of the second carrier 32C. The second carrier 32C and the sun gear 33S rotate together. The second carrier 32C and the sun gear 33S may be integrated or separated (separate parts). Pins 33A are provided on the third carrier 33C. The planetary gears 33P are rotatably supported on the pins 33A, respectively. The third carrier 33C supports the planetary gears 33P in a rotatable manner via the respective pins 33A. The third carrier 33C rotates integrally with the spindle 81 as described above.

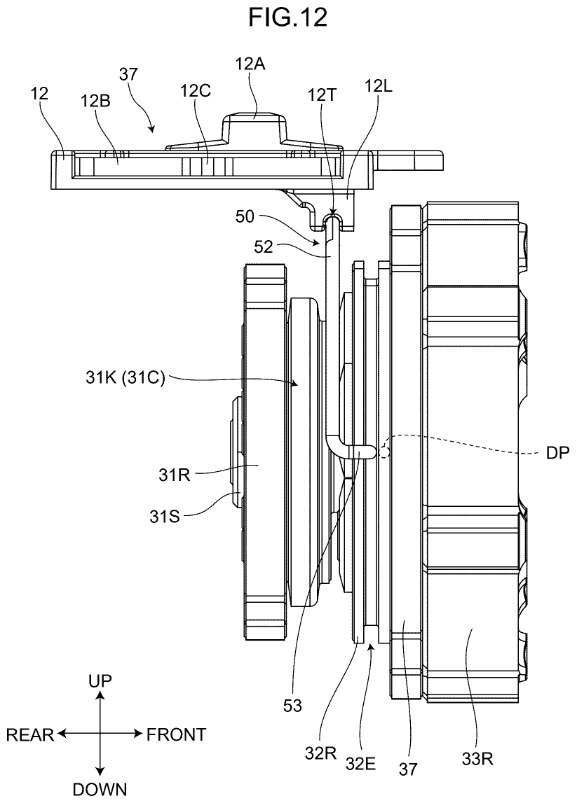

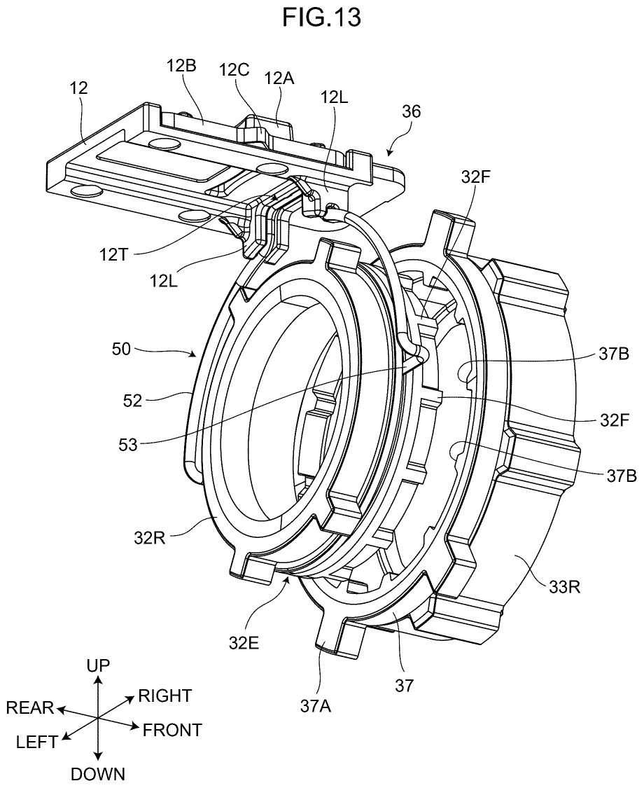

FIG. 12 is a side view illustrating a speed changing mechanism 36 according to the embodiment. FIG. 13 is a perspective view illustrating the speed changing mechanism 36 according to the embodiment as viewed from lower right rear. The speed reducing mechanism 30 includes the speed changing mechanism 36. The speed changing mechanism 36 is switchable between the low-speed mode and the high-speed mode. In the embodiment, in the low-speed mode, the speed reducing function of the second planetary gear mechanism 32 is enabled. In the high-speed mode, the speed reducing function of the second planetary gear mechanism 32 is disabled. Enabling the second planetary gear mechanism 32 includes blocking rotation of the internal gear 32R. Disabling the second planetary gear mechanism 32 includes permitting rotation of the internal gear 32R.

The speed changing mechanism 36 includes the speed changing lever 12, a switching wire 50, and the locking ring 37. The speed changing mechanism 36 is switchable between the low-speed mode and the high-speed mode by moving the internal gear 32R in the front-rear direction using the switching wire 50.

The switching wire 50 is a metallic wire member having a rigidity (spring constant) required to move the internal gear 32R. The switching wire 50 is disposed outside the gear case 4A. The switching wire 50 is movable in the front-rear direction outside the gear case 4A. A tip portion of the switching wire 50 is inserted into a groove 32E provided on the internal gear 32R. As illustrated in FIGS. 7 and 8, through holes 4J are provided in the gear case 4A. The switching wire 50 passes through the through holes 4J of the gear case 4A, and couples the speed changing lever 12 with the speed reducing mechanism 30. The speed changing lever 12 is disposed upward of the gear case 4A. An upper end portion of the switching wire 50 is fixed to the lower surface of the speed changing lever 12. The tip portion of the switching wire 50 is disposed inside the gear case 4A via the through holes 4J. The tip portion of the switching wire 50 is inserted into the groove 32E inside the gear case 4A. The switching wire 50 and the internal gear 32R integrally move in the front-rear direction.

An upper portion of the switching wire 50 is fixed to the speed changing lever 12. The speed changing lever 12 is disposed upward of the gear case 4A. The speed changing lever 12 holds the switching wire 50 on the lower surface facing the gear case 4A. The speed changing lever 12 and the switching wire 50 integrally move in the front-rear direction. Therefore, when the speed changing lever 12 is operated (manually moved) in the front-rear direction, the internal gear 32R moves in the front-rear direction as the switching wire 50 moves in the front-rear direction.

The locking ring 37 is provided forward of the internal gear 32R. The locking ring 37 is housed in the gear housing 4B. The locking ring 37 is disposed between the inner surface of the gear housing 4B and the front end surface of the gear case 4A, whereby movement of the locking ring 37 in the front-rear direction is blocked. A plurality of projections 37A is provided on the outer circumferential surface of the locking ring 37. The projections 37A are disposed inside recesses 4G (see FIG. 7) formed on the front end surface of the gear case 4A to block rotation of the locking ring 37. The locking ring 37 has an inner diameter larger than the outer diameter of the internal gear 32R. The internal gear 32R is insertable into and removable from the locking ring 37. A plurality of cam teeth 37B is provided on the inner circumferential surface of the locking ring 37.

A plurality of cam teeth 32F is provided on the outer circumferential surface of the internal gear 32R. The cam teeth 32F are formed forward of the groove 32E. The cam teeth 32F mesh with the cam teeth 37B of the locking ring 37. By inserting the internal gear 32R into the locking ring 37, rotation of the internal gear 32R is blocked by the cam teeth 37B of the locking ring 37.

By manually moving the speed changing lever 12 in the front-rear direction, the switching wire 50 moves in the front-rear direction, whereby the internal gear 32R also moves in the front-rear direction. By moving the movement of the internal gear 32R in the front-rear direction, the internal gear 32R is switched from the state in which the internal gear 32R is inserted into the locking ring 37 to the state in which the internal gear 32R is removed from the locking ring 37 and vice versa.

By moving the speed changing lever 12, the switching wire 50, and the internal gear 32R forward, inserting at least a part of the internal gear 32R into the locking ring 37, and meshing the cam teeth 32F of the internal gear 32R with the cam teeth 37B of the locking ring 37, rotation of the internal gear 32R is blocked. That is, by moving the speed changing lever 12, the switching wire 50, and the internal gear 32R forward and blocking rotation of the internal gear 32R, the second planetary gear mechanism 32 is enabled.

On the other hand, by moving the speed changing lever 12, the switching wire 50, and the internal gear 32R rearward, removing the internal gear 32R from the inside of the locking ring 37, and separating the cam teeth 32F of the internal gear 32R from the cam teeth 37B of the locking ring 37, rotation of the internal gear 32R is permitted. That is, by moving the speed changing lever 12, the switching wire 50, and the internal gear 32R rearward and permitting rotation of the internal gear 32R, the second planetary gear mechanism 32 is disabled.

When the second planetary gear mechanism 32 is enabled, the internal gear 32R meshes only with the planetary gears 32P. When the second planetary gear mechanism 32 is disabled, the internal gear 32R meshes with both the planetary gears 32P and the external tooth gear 31K on the outer circumferential portion of the first carrier 31C.

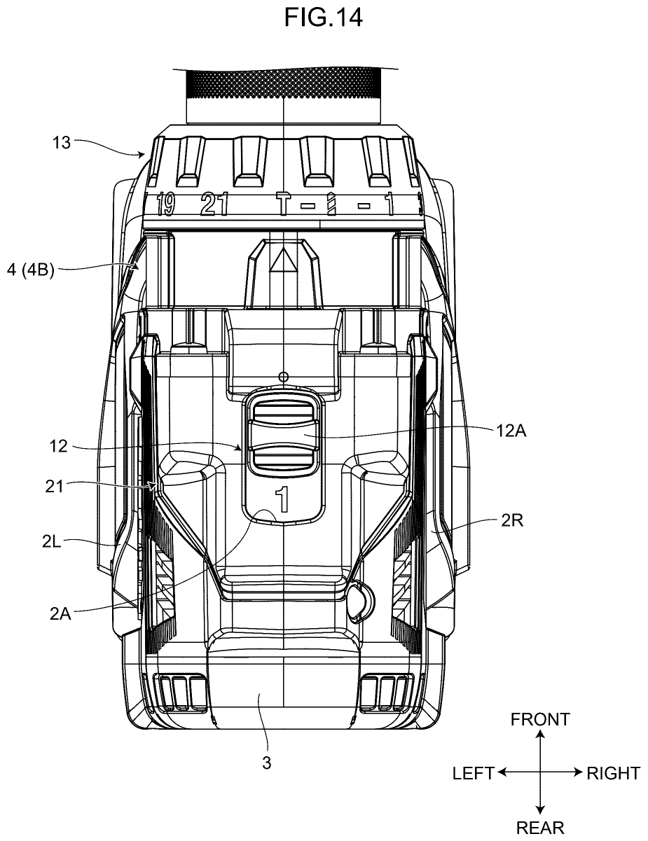

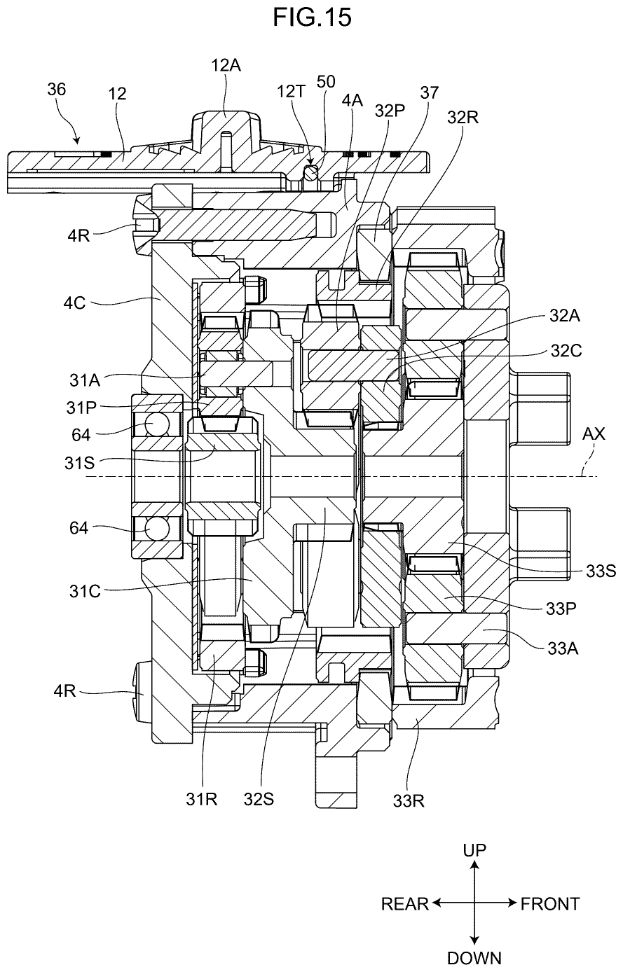

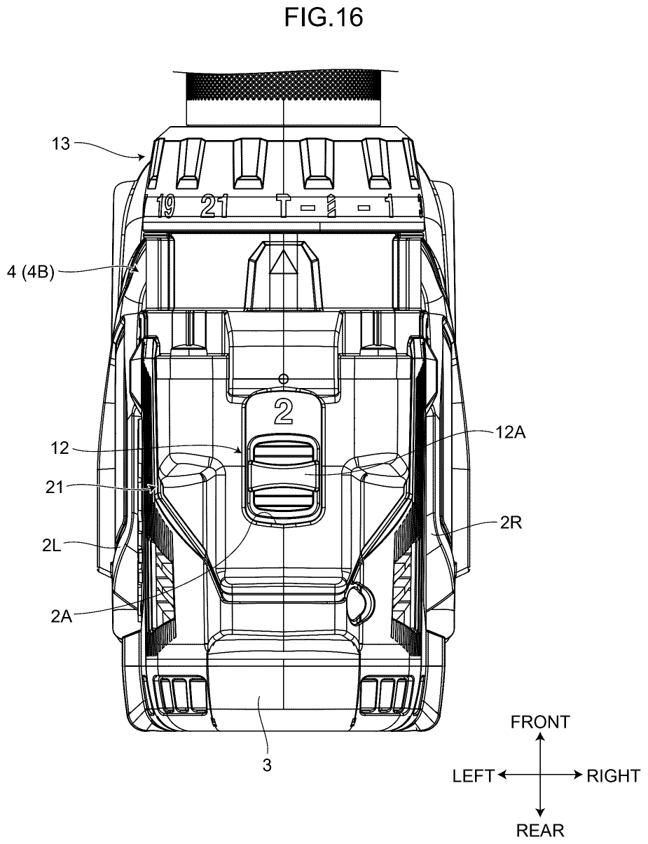

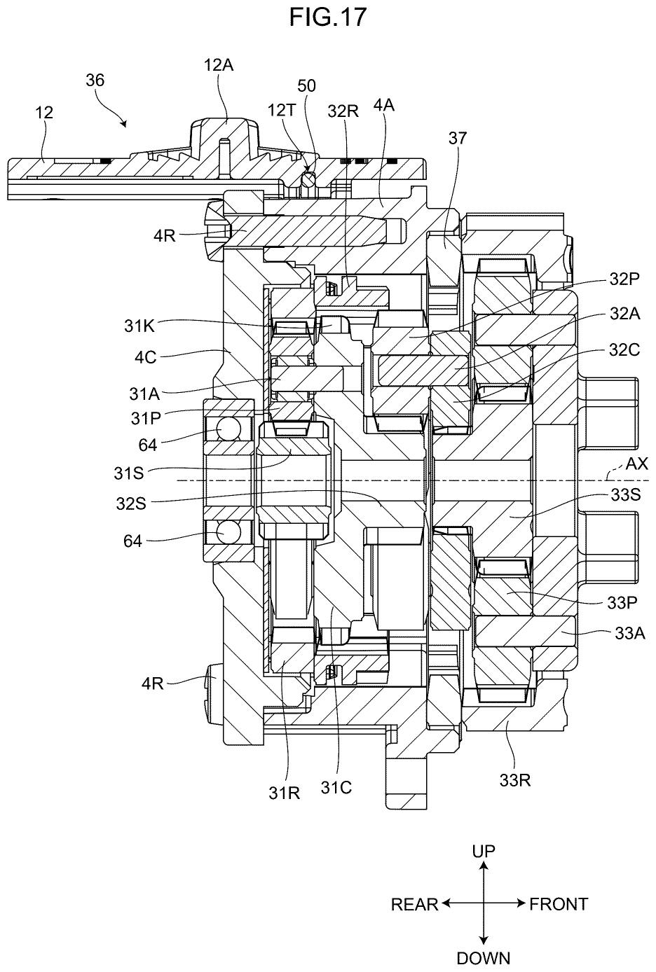

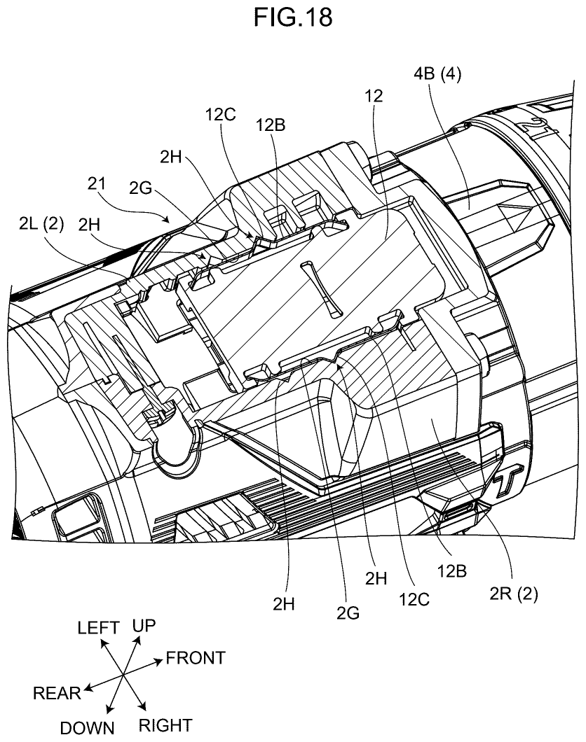

FIG. 14 illustrates the power tool 1 in a case where the speed reducing mechanism 30 according to the embodiment is set to the low-speed mode as viewed from above. FIG. 15 is a cross-sectional view illustrating the speed reducing mechanism 30 in a case where the speed reducing mechanism 30 according to the embodiment is set to the low-speed mode. FIG. 16 illustrates the power tool 1 in a case where the speed reducing mechanism 30 according to the embodiment is set to the high-speed mode as viewed from above. FIG. 17 is a cross-sectional view illustrating the speed reducing mechanism 30 in a case where the speed reducing mechanism 30 according to the embodiment is set to the high-speed mode. FIG. 18 is a horizontal cross-sectional view of a location of engagement between the speed changing lever 12 and the housing 2 as viewed from above.

The movable range of the speed changing lever 12 is defined in the front-rear direction. The movable range has a linear shape along the front-rear direction. The movable range is along the rotation axis AX. In the embodiment, the movable range is defined by an inner peripheral edge of an opening 2A formed in the housing 2. The opening 2A is formed in an upper portion of the housing 2. The opening 2A exposes the upper surface of the speed changing lever 12. A knob part (tab, ridge) 12A is formed on the upper surface of the speed changing lever 12. The knob part 12A protrudes upward into the opening 2A.

The speed changing lever 12 is movable (slidable) within the movable range, which includes a plurality of speed-change positions. In the embodiment, the speed reducing mechanism 30 is a two stage gear shifting mechanism, and therefore two speed-change positions that respectively correspond to the low-speed mode and the high-speed mode are defined in the movable range. A speed-change position for the low-speed mode is defined at the front end of the movable range. A speed-change position for the high-speed mode is defined at the rear end of the movable range.

By operating the speed changing lever 12 such that it moves (is slid) to the speed-change position for the low-speed mode in front, the speed mode of the speed reducing mechanism 30 is set to the low-speed mode (speed “1”). By operating the speed changing lever 12 such that it moves to the speed-change position for the high-speed mode in rear, the speed mode of the speed reducing mechanism 30 is set to the high-speed mode (speed “2”).

As illustrated in FIG. 18, the speed changing lever 12 moves in the front-rear direction while being guided by the housing 2 on both the right and left sides. The speed changing lever 12 is operated (manually slid) by the user, the speed changing lever 12 moves in the front-rear direction. Plate springs 12B (see FIG. 7) having projections 12C are provided on both right and left side surfaces of the speed changing lever 12. The plate springs 12B come in contact with guide surfaces 2G of the housing 2 at the projections 12C and slide while elastically deforming along the guide surfaces 2G as the speed changing lever 12 moves. Engaging recesses 2H are formed on the guide surfaces 2G. When the projections 12C of the plate springs 12B reach the positions of the engaging recesses 2H, elastic restoring forces of the plate springs 12B cause the projections 12C to enter the engaging recesses 2H. The projections 12C enter the engaging recesses 2H, whereby the position of the speed changing lever 12 is held so as not to be moved by unintended external force. The engaging recesses 2H are formed at the speed-change position for the low-speed mode and at the speed-change position for the high-speed mode. When switching between the low-speed mode and the high-speed mode, an external force exceeding a predetermined amount is applied to the speed changing lever 12. The plate springs 12B are thereby elastically deformed, and the projections 12C move away (out) from the engaging recesses 2H. Thus, the engagement between the projections 12C and the engaging recesses 2H are released, which allows the speed changing lever 12 to move.

As illustrated in FIGS. 14 and 15, when the speed changing lever 12 is located at the speed-change position for the low-speed mode (the front end of movable range), the switching wire 50 and the internal gear 32R are disposed at the low-speed mode position on the front side. The internal gear 32R is inserted into the locking ring 37 and is blocked from rotating by the locking ring 37. When the rotor shaft 63 is rotated by the motor 6 with the internal gear 32R being disposed at the low-speed mode position, the pinion gear 31S rotates, and the planetary gears 31P revolve around the pinion gear 31S. The revolution of the planetary gears 31P causes the first carrier 31C and the sun gear 32S to rotate at a rotational speed lower than that of the rotor shaft 63. When the sun gear 32S rotates, the planetary gears 32P revolve around the sun gear 32S (inner circumference of internal gear 32R). The revolution of the planetary gears 32P causes the second carrier 32C and the sun gear 33S to rotate at a rotational speed lower than that of the first carrier 31C. In this manner, when the motor 6 is driven with the internal gear 32R being disposed at the low-speed mode position, both the speed reducing function of the first planetary gear mechanism 31 and the speed reducing function of the second planetary gear mechanism 32 are exerted. Thus, the second carrier 32C and the sun gear 33S rotate in the low-speed mode.

As illustrated in FIGS. 16 and 17, when the speed changing lever 12 is located at the speed-change position for the high-speed mode (rear end portion of movable range), the switching wire 50 and the internal gear 32R are disposed at the high-speed mode position on the rear side. The internal gear 32R is removed from the locking ring 37, whereby rotation of the internal gear 32R in the gear case 4A is permitted. When the rotor shaft 63 is rotated by the motor 6 with the internal gear 32R being disposed at the high-speed mode position, the pinion gear 31S rotates, and the planetary gears 31P revolve around the pinion gear 31S. The revolution of the planetary gears 31P causes the first carrier 31C and the sun gear 32S to rotate at a rotational speed lower than that of the rotor shaft 63. The internal gear 32R meshes with both the planetary gears 32P and the external tooth gear 31K of the first carrier 31C with the internal gear 32R being disposed at the high-speed mode position, whereby the internal gear 32R and the first carrier 31C rotate together. The rotation of the internal gear 32R causes the planetary gears 32P to revolve at a revolution speed equal to the rotational speed of the internal gear 32R. The revolution of the planetary gears 32P causes the second carrier 32C and the sun gear 33S to rotate at a rotational speed equal to that of the first carrier 31C. As described above, when the motor 6 is driven in the high-speed mode, the speed reducing function of the second planetary gear mechanism 32 is not exerted, but the speed reducing function of the first planetary gear mechanism 31 is exerted. Thus, the second carrier 32C and the sun gear 33S rotate in the high-speed mode.

### Switching wire and Attachment Structure of Gear Case

Next, the shape of the switching wire 50 and an attachment structure of the gear case 4A according to the embodiment will be described.

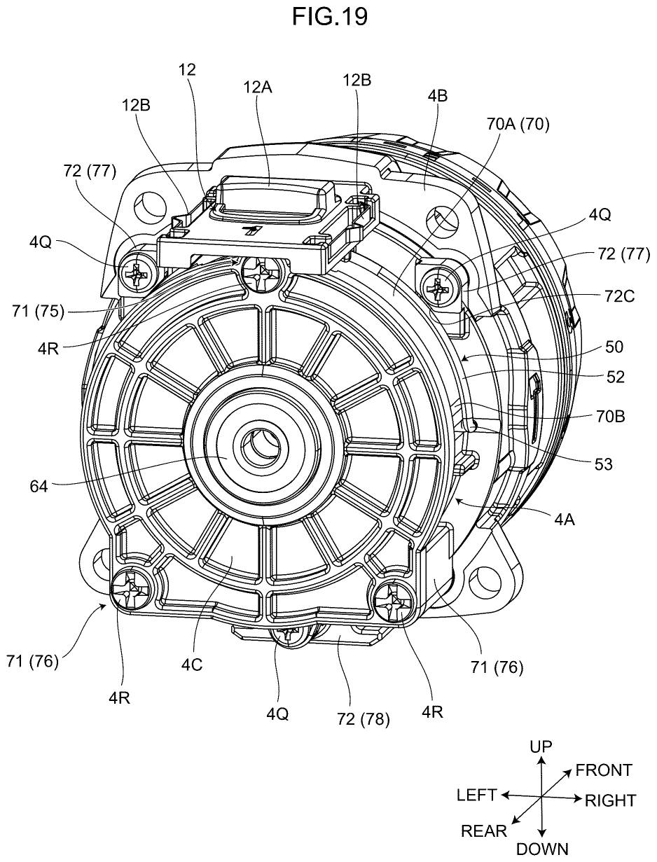

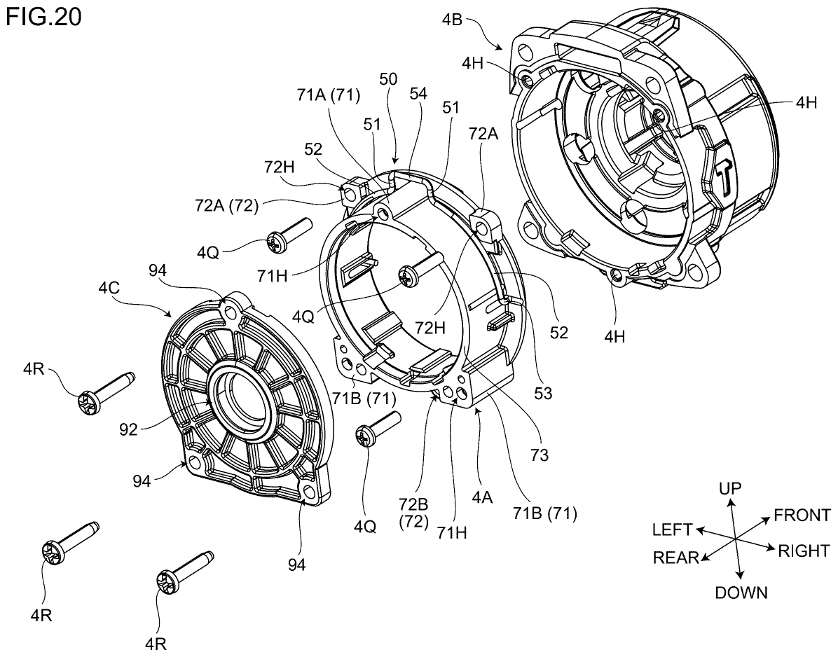

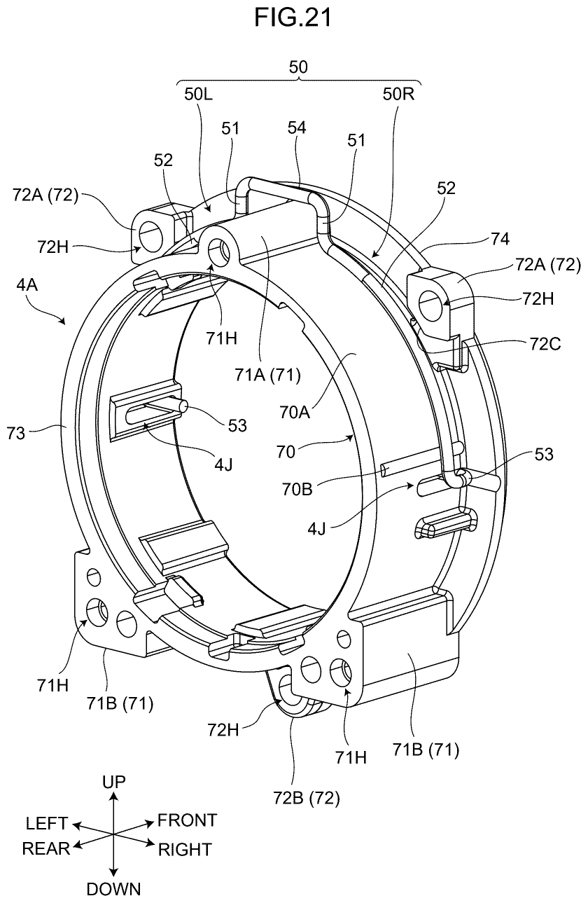

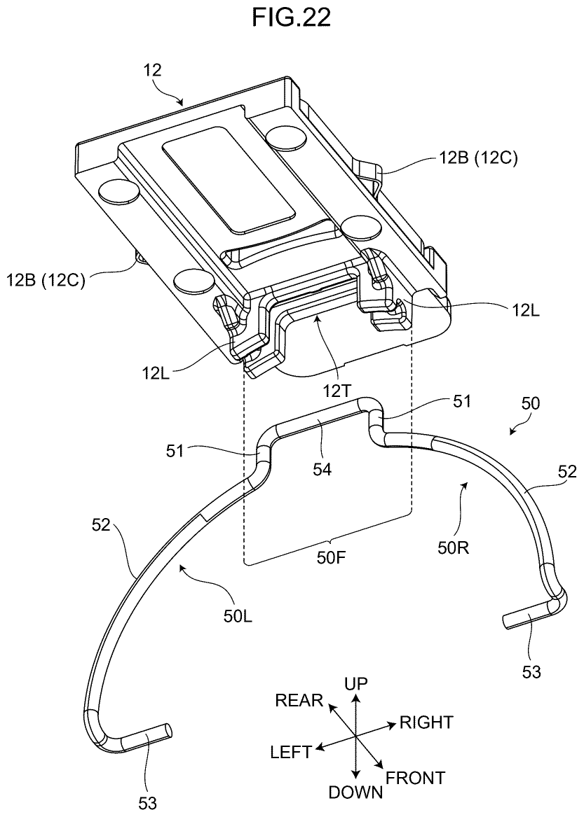

FIG. 19 is a perspective view illustrating the gear case 4A, the motor bracket 4C, and the gear housing 4B according to the embodiment as viewed from rear. FIG. 20 is an exploded perspective view illustrating the gear case 4A, the motor bracket 4C, and the gear housing 4B according to the embodiment as viewed from rear. FIG. 21 is a perspective view illustrating the speed changing lever 12 and the switching wire 50 according to the embodiment as viewed from below. FIG. 22 is a perspective view illustrating the gear case 4A and the switching wire 50 according to the embodiment as viewed from rear.

As illustrated in FIGS. 19 and 20, in the embodiment, the gear case 4A is fixed to the motor bracket 4C and the gear housing 4B by separated screws.

Specifically, the gear case 4A includes a cylindrical part 70, a plurality of bracket boss parts 71, and a plurality of housing boss parts 72. The bracket boss parts 71 are screw receiving portions to which screws 4R for fixing the motor bracket 4C are mounted. The motor bracket 4C is fixed to the bracket boss parts 71 by screws 4R. The housing boss parts 72 are screw insertion portions into which screws 4Q for fixing the gear case 4A to the gear housing 4B are inserted. The gear case 4A is fixed to the gear housing 4B by the screws 4Q inserted into the housing boss parts 72.

As illustrated in FIG. 21, the cylindrical part 70 is a body portion of the gear case 4A, and has a cylindrical shape extending in the front-rear direction. The gear case 4A houses the speed reducing mechanism 30 inside the cylindrical part 70. A front end and a rear end of the cylindrical part 70 are opened. A first mating surface 73 with the motor bracket 4C is formed on the end surface of the rear end (rear end surface) of the cylindrical part 70. A flange portion 74 is provided at a front end of the cylindrical part 70. The flange portion 74 extends radially outward. An outer circumferential surface 70A of the cylindrical part 70 is substantially entirely formed of a circumferential curved surface.

The cylindrical part 70 has the through holes 4J penetrating therethrough in the radial direction. That is, the through holes 4J penetrate the cylindrical part 70 from the outer circumferential surface to the inner circumferential surface. The switching wire 50 is inserted into the through holes 4J. The through holes 4J are long holes extending along the front-rear direction, and permit movement of the switching wire 50 in the front-rear direction in accordance with an operation (movement) of the speed changing lever 12. The through holes 4J have a length in the front-rear direction equal to or larger than a movement range of the switching wire 50 in the front-rear direction, that is, equal to or larger than the length of the movable range of the speed changing lever 12. The gear case 4A has two through holes 4J provided on one side and the other side in a lateral direction (left-right direction). The one side and the other side in the lateral direction are namely a right side surface and a left side surface of the gear case 4A. The through holes 4J are disposed on the right and left sides with respect to the center axis of the cylindrical part 70.

The bracket boss parts 71 are provided on the outer circumference of the cylindrical part 70. In the embodiment, three bracket boss parts 71 are provided. Each of the bracket boss parts 71 protrudes radially outward from an outer circumferential surface 70A of the cylindrical part 70. Each of the bracket boss parts 71 extends in the front-rear direction from the front end to the rear end of the cylindrical part 70. Screw holes 71H are formed in the bracket boss parts 71, respectively. The screw holes 71H extend in the front-rear direction. The screws 4R mesh with and are mounted on these screw holes 71H, respectively. This causes the motor bracket 4C to be fixed to the bracket boss parts 71 by the screws 4R.

The housing boss parts 72 are provided on the outer circumference of the cylindrical part 70. In the embodiment, three housing boss parts 72 are provided. The housing boss parts 72 are provided on the front end of the cylindrical part 70. In (on) the flange portion 74 of the gear case 4A, the housing boss parts 72 are provided radially outward from the outer circumferential surface 70A of the cylindrical part 70. The housing boss parts 72 have a thickness in the front-rear direction larger than another portion of the flange portion 74. Insertion holes 72H are formed in the housing boss parts 72, respectively. The insertion holes 72H extend in the front-rear direction. The screws 4Q are inserted into the insertion holes 72H, respectively. The screws 4Q that have passed through the insertion holes 72H are mounted in screw holes 4H formed in the gear housing 4B, respectively. This causes the gear case 4A to be fixed to the gear housing 4B by the screws 4Q that have passed through the three housing boss parts 72.

The arrangement of the bracket boss parts 71 and the housing boss parts 72 in the gear case 4A will be described later.

As illustrated in FIGS. 21 to 24, the switching wire 50 includes a first wire portion 50R provided on one side (right side) and a second wire portion 50L provided on another side (left side). Each of the first wire segment 50R and the second wire portion 50L includes a wire segment 51, a second wire segment 52, and a third wire segment 53. The first wire segments 51 extends from the speed changing lever 12 to the cylindrical part 70 as viewed from the axial direction. The second wire segments 52 extends in the circumferential direction along the outer circumferential surface 70A of the cylindrical part 70 from an end of the first wire segment 51. The third wire segments 53 is inserted from an end of the second wire segment 52 into the through hole 4J.

The switching wire 50 is inserted into the through holes 4J provided on one side and the other side of the gear case 4A. As described above, the switching wire 50 includes the first wire portion 50R on one side (right side) and the second wire portion 50L on the other side (left side). The first wire portion 50R is inserted into the through hole 4J on one side (right side). The second wire portion 50L is inserted into the through hole 4J on the other side (left side). The first wire portion 50R includes the first wire segment 51, the second wire segment 52, and the third wire segment 53 on the right side. The second wire portion 50L includes the first wire segment 51, the second wire segment 52, and the third wire segment 53 on the left side. The switching wire 50 is substantially symmetric. The first wire portion 50R and the second wire portion 50L have the same structure, and have a shape symmetric in the left-right direction. Being substantially symmetric means that even when there is an unavoidable difference such as dimensional tolerance (resulting in (asymmetric shape), they are still considered as being symmetric.

The first wire portion 50R and the second wire portion 50L are connected to each other via their first wire segments 51. The switching wire 50 includes a connection portion 54 that connects an upper end of the first wire segment 51 of the first wire portion 50R with an upper end of the first wire segment 51 of the second wire portion 50L. The connection portion 54 extends along the left-right direction. In the embodiment, the switching wire 50 is a single part including the first wire portion 50R and the second wire portion 50L, which are connected by the connection portion 54. Alternatively, the first wire portion 50R and the second wire portion 50L may be separated parts.

The first wire segments 51 extend along an up-down direction between the speed changing lever 12 and the cylindrical part 70. The first wire segments 51 have a linear shape. The upper ends of the first wire segments 51 are connected to the connection portion 54. The lower ends of the first wire segments 51 are disposed in the vicinity of the outer circumferential surface of the cylindrical part 70 of the gear case 4A. The lower ends of the first wire segments 51 face the outer circumferential surface of the cylindrical part 70 with a slight gap therebetween. The first wire segments 51 are not in contact with the outer circumferential surface of the cylindrical part 70.

The second wire segments 52 connect the ends of the first wire segments 51 with ends of the third wire segments 53. The second wire segments 52 extend in an arc shape along the outer circumferential surface 70A of the cylindrical part 70. The second wire segments 52 face the outer circumferential surface 70A of the cylindrical part 70 with a slight gap therebetween.

The third wire segments 53 are connected to the ends of the second wire segments 52. The third wire segments 53 are disposed at positions facing the through holes 4J of the gear case 4A in the radial direction. The third wire segments 53 are slightly bent forward from the ends of the second wire segments 52, and then extend radially inward. Tip portions of the third wire segments 53 pass through the through holes 4J of the cylindrical part 70, and are disposed inside the cylindrical part 70. This causes the tip portions of the third wire segments 53 to be disposed inside the groove 32E of the internal gear 32R.

As illustrated in FIG. 22, the switching wire 50 includes a held portion 50F held by the speed changing lever 12. In the embodiment, the held portion 50F includes the connection portion 54. Specifically, a holding groove 12T is formed on the lower surface of the speed changing lever 12. The holding groove 12T is recessed upward, and extends in the left-right direction. The connection portion 54 at an upper end of the switching wire 50 is fitted into the holding groove 12T.

A pair of holding legs 12L are provided on the lower surface of the speed changing lever 12. The pair of holding legs 12L protrude downward toward the gear case 4A. The pair of holding legs 12L are disposed on the right and left sides of the holding groove 12T. The pair of holding legs 12L extend toward the vicinity of upper ends of the second wire segments 52 (immediately before positions of connections with first wire segments 51) of the switching wire 50. The holding groove 12T is continuous from the inner side surfaces to lower end surfaces of the pair of holding legs 12L. The inner side surfaces of the pair of holding legs 12L are side surfaces of the pair of holding legs 12L, which face each other in the left-right direction. The holding groove 12T extends in the up-down direction along the inner side surfaces of the pair of holding legs 12L. The holding groove 12T extends along the left-right direction on the lower end surfaces of the pair of holding legs 12L.

The first wire segments 51 and the vicinities of the upper ends of the second wire segments 52 of the switching wire 50 are fitted into the holding groove 12T formed in the pair of holding legs 12L. The first wire segments 51 are disposed in the holding groove 12T of the inner side surfaces of the pair of holding legs 12L. The vicinities of the upper ends of the second wire segments 52 are fitted into the holding groove 12T formed on the lower end surfaces of the pair of holding legs 12L. Therefore, in the embodiment, the held portion 50F further includes the pair of first wire segments 51 and the vicinities of the upper ends of the pair of the second wire segments 52 in addition to the connection portion 54. The held portion 50F is disposed in the holding groove 12T, whereby the switching wire 50 is fixed to the speed changing lever 12.

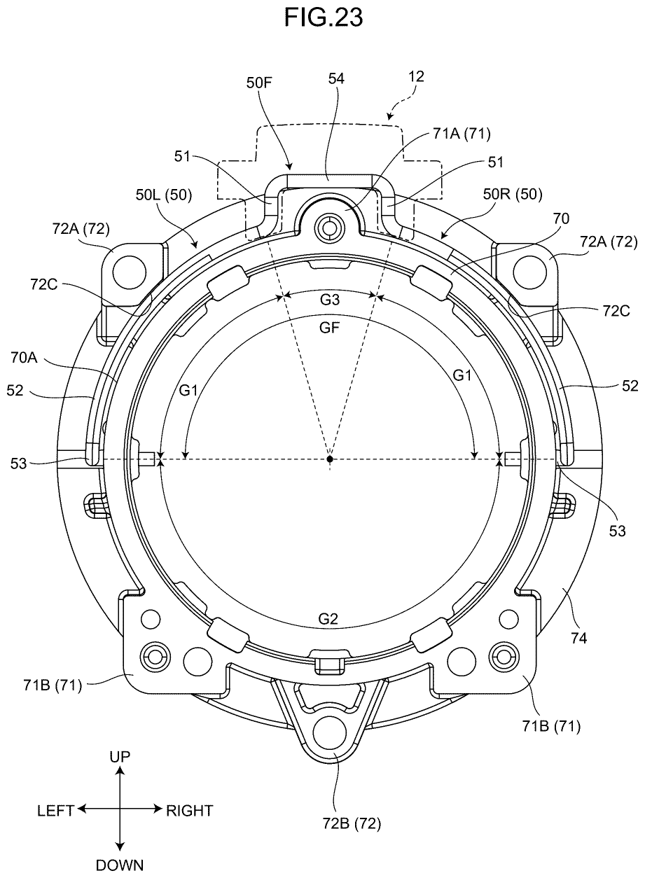

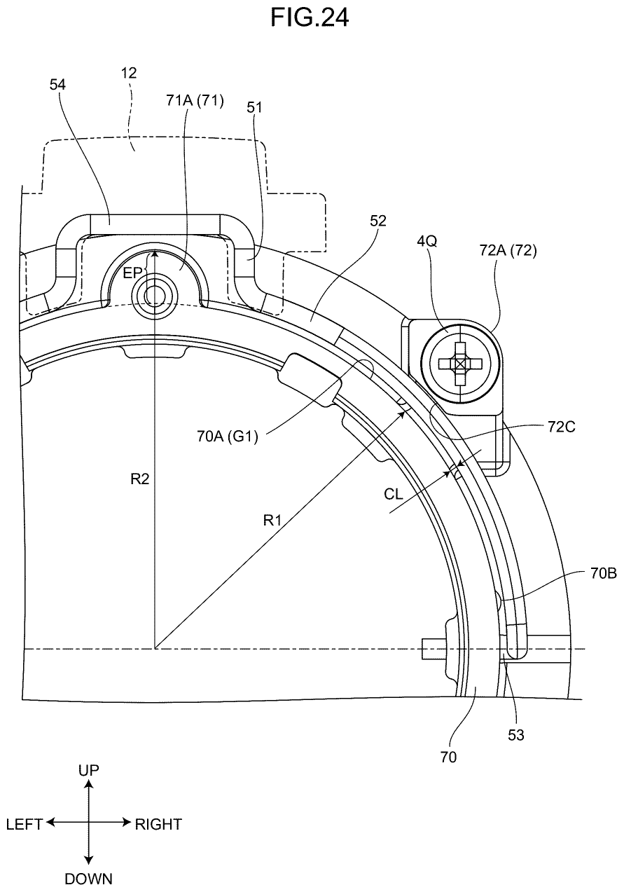

Next, the positional relation between the segments of the switching wire 50 and the gear case 4A will be described in detail. FIG. 23 is an arrow view of the gear case 4A and the switching wire 50 according to the embodiment as viewed in the axial direction from rear. FIG. 24 is an enlarged view of a vicinity of the first wire segment 51 and the second wire segment 52 of the switching wire 50 in FIG. 23.

The gear case 4A according to the embodiment has a structure in which the path length of the switching wire 50 can be shortened. The path length of the switching wire 50 in the present disclosure refers to the length of the switching wire 50 from an end of the portion of the switching wire 50 held by the speed changing lever 12 (i.e., the holding leg 12L) to a bent portion (boundary portion between second wire segment 52 and third wire segment 53) on a tip side. The path length of the switching wire 50 corresponds to the length of the second wire segment 52.

Here, in order to specify the position of the gear case 4A, first regions G1 and a second region G2 will be defined below.

The first regions G1 are regions, which are respectively face the second wire segments 52 of the switching wire 50 in the radial direction, on the outer circumference of the cylindrical part 70. The first regions G1 are included in angle ranges from ends (portions of connection with first wire segments 51) to the other ends (positions of through holes 4J) of the second wire segments 52 in the circumferential direction of the cylindrical part 70. Since there are the first wire portion 50R and the second wire portion 50L, the first regions G1 are provided on one side and the other side of the cylindrical part 70 in the left-right direction. The first regions G1 can be said to be regions obtained by removing a third region G3 between the pair of first wire segments 51 of the upper half of the outer circumferential surface 70A of the cylindrical part 70.

The second region G2 is provided below the through holes 4J on the outer circumference of the cylindrical part 70. The second region G2 does not face the second wire segments 52 of the switching wire 50 in the radial direction on the outer circumference of the cylindrical part 70. In the embodiment, the through holes 4J are located on both the right and left sides (i.e., middle in up-down direction) with respect to the center axis of the cylindrical part 70, so that the second region G2 is a lower half region of the outer circumferential surface 70A of the cylindrical part 70. The second region G2 can be said to be a non-facing region that does not face the switching wire 50 in the radial direction, on the outer circumference of the cylindrical part 70.

### Bracket Boss Part

In the embodiment, the bracket boss parts 71 of the gear case 4A are provided at positions other than the first regions G1, which are respectively face the second wire segments 52 in the radial direction, on the outer circumference of the cylindrical part 70. Each of the three bracket boss parts 71 is not provided in the first regions G1, and provided outside the first regions G1 of the cylindrical part 70 in the circumferential direction. Thus, the second wire segments 52 of the switching wire 50 do not face the bracket boss parts 71 in the radial direction. Therefore, the second wire segments 52 can have an arc shape along the outer circumferential surface 70A of the cylindrical part 70 without going around the outer circumferences of the bracket boss parts 71.

More specifically, the bracket boss parts 71 include one first boss 71A and two second bosses 71B. The first boss 71A is disposed between the first wire segment 51 of the first wire portion 50R and the first wire segment 51 of the second wire portion 50L. The first boss 71A is disposed at a position of the third region G3 between the first region G1 on one side (right side) and the first region G1 on the other side (left side) in the left-right direction. The first boss 71A is provided at the position where the cylindrical part 70 faces the speed changing lever 12. That is, the first boss 71A is disposed at an upper end of the center in the left-right direction of the cylindrical part 70. The first boss 71A is provided at a position facing the held portion 50F of the switching wire 50 in the radial direction, as viewed from the axial direction. In the embodiment, the held portion 50F includes the pair of first wire segments 51 and the connection portion 54 of the switching wire 50. The first boss 71A is surrounded by the pair of first wire segments 51 and the connection portion 54. That is, in the switching wire 50, the pair of first wire segments 51 and the connection portion 54 form rectangular recessed space recessed upward. The first boss 71A is disposed inside the rectangular recessed space.

The second bosses 71B are provided in the second region G2 below the through holes 4J on the outer circumference of the cylindrical part 70. The second bosses 71B are disposed on one side and the other side in the lateral direction of the cylindrical part 70 in the second region G2. That is, the two second bosses 71B are disposed between lateral ends of the cylindrical part 70 and the lower end of the cylindrical part 70. The two second bosses 71B are disposed on one side (right side) and the other side (left side) of the first boss 71A.

In an example of FIG. 23, when the angle around the center axis of the cylindrical part 70 is defined with the upper end of the cylindrical part 70 as being 0 degrees, the first boss 71A is disposed at the position of 0 degrees. The two second bosses 71B are disposed at positions of approximate 140 degrees on the right side and the left side. In this manner, in the embodiment, the three bracket boss parts 71 are arranged in a triangular shape as viewed from the axial direction. The distances in the left-right direction between the second bosses 71B and the first boss 71A are equal. The three bracket boss parts 71 are arranged in a shape of an isosceles triangle.

In this manner, the three bracket boss parts 71 are provided at the positions other than the first regions G1, whereby the second wire segments 52 of the switching wire 50 do not need to go around the outside of the bracket boss parts 71. Thus, the second wire segments 52 can be brought closer to the first regions G1 and extended along the first regions G1, thereby shortening the path length of the second wire segment 52. Furthermore, the first wire segments 51 and the connection portion 54 protrude upward (radially outward) to be coupled to the speed changing lever 12. The first boss 71A is disposed not in the first regions G1 but in such a protruding portion, whereby the bracket boss parts 71 do not increase the path length of the switching wire 50.

As illustrated in FIG. 24, a radial distance CL between the second wire segment 52 of the switching wire 50 and the outer circumferential surface 70A of the cylindrical part 70 in the first region G1 is smaller than a protrusion amount EP of the bracket boss part 71 with respect to the outer circumferential surface 70A in the first region G1. The protrusion amount EP of the bracket boss parts 71 with respect to the outer circumferential surface 70A of the first regions G1 is the difference between a radius R1 and a radius R2. The radius R1 is a distance from the center axis of the cylindrical part 70 to the outer circumferential surface 70A of the first regions G1. The radius R2 is a distance from the center axis of the cylindrical part 70 to a point (referred to as outermost point) on the radially outermost side of the bracket boss part 71. The first boss 71A among the three bracket boss parts 71 has the smallest protrusion amount EP. The distance CL is smaller than the protrusion amount EP of the first boss 71A. The entire second wire segment 52 is located radially inside the outermost point of the first boss 71A.

Restriction ribs 70B (see FIG. 21) are provided at positions facing the second wire segments 52 on the outer circumferential surface 70A of the cylindrical part 70. The restriction ribs slightly protrude radially outward. The restriction ribs 70B are disposed at positions slightly above the vicinity of the through holes 4J. In principle, the restriction ribs 70B face the second wire segments 52 in a non-contact manner in the radial direction. When the second wire segment 52 is displaced (deformed) radially inward from its design position due to vibration caused by an operation of the speed changing lever 12 or a movement of the power tool 1, dimensional variation in within tolerance range, or the like; the restriction rib 70B comes in contact with the second wire segment 52, to thereby block the second wire segment 52 from coming in contact with the outer circumferential surface 70A of the cylindrical part 70. Therefore, the second wire segment 52 is not in contact with the outer circumferential surface 70A of the cylindrical part 70 excluding the restriction rib 70B. The minimum value of the distance CL of the second wire segment 52 corresponds to the height (protrusion amount) of the restriction rib 70B, and is not zero. The height (protrusion amount) of the restriction rib 70B from the outer circumferential surface 70A of the cylindrical part 70 is smaller than the wire diameter of the switching wire 50. The height (protrusion amount) of the restriction rib 70B is smaller than half the wire diameter of the switching wire 50. Furthermore, the distance CL between the second wire segment 52 and the outer circumferential surface 70A excluding the restriction rib 70B is smaller than the wire diameter of the switching wire 50. In an example of FIG. 24, the distance CL between the second wire segment 52 and the outer circumferential surface 70A excluding the restriction rib 70B is smaller than half the wire diameter of the switching wire 50.

When the switching wire 50 is located at the position for the low-speed mode, which is the front end of its movable range, the switching wire 50 is fitted into the groove 32E with the tip portion of the switching wire 50 being elastically deformed rearward. Specifically, on design, as illustrated in FIG. 12, the switching wire 50 is designed such that, when located at the position for the low-speed mode, the tip portion of the third wire segment 53 is disposed at its design position DP offset forward from the groove 32E.

When the switching wire 50 and the internal gear 32R are located at the position for the low-speed mode on the front side, the front surface of the internal gear 32R comes in contact with the cam teeth 37B of the locking ring 37, which prevents further forward movement. Thus, the switching wire 50 is elastically deformed such that its tip portion is displaced rearward from its design position DP to the position of the groove 32E. For convenience, the elastic deformation of the switching wire 50 is not illustrated in the figures.

When the internal gear 32R is located at the position for the low-speed mode on the front side, the tip portion of the switching wire 50 is elastically deformed rearward, so that the switching wire 50 biases the internal gear 32R forward toward the locking ring 37 by elastic restoring force. The internal gear 32R is biased toward the locking ring 37, which inhibits the position of the internal gear 32R from being shifted rearward. Thus, even when reaction force from another gear and the locking ring 37, vibration at the time when the power tool 1 moves, or the like act on the internal gear 32R, positional shift of the internal gear 32R is prevented, thereby suppressing the engagement with the locking ring 37 from being unintentionally released.

The magnitude of forward biasing force acting on the internal gear 32R depends on the spring constant (rigidity) of the switching wire 50. In the embodiment, the path length of the switching wire 50 can be shortened. Therefore, the spring constant of the switching wire 50 increases, and biasing force on the internal gear 32R can be increased. As a result, unintended positional shift of the internal gear 32R can be effectively inhibited, achieving more reliable gear shifting.

### Housing Boss Part

As illustrated in FIGS. 21 and 23, the plurality of housing boss parts 72 is disposed outside the switching wire 50 in the radial direction. The plurality of (three) housing boss parts 72 includes two third bosses 72A and one fourth boss 72B. The two third bosses 72A are disposed outside the switching wire 50 in the radial direction. The fourth boss 72B is disposed in the second region G2 where the switching wire 50 is not positioned.

The third bosses 72A are disposed in the first regions G1 of the outer circumferential surface 70A of the cylindrical part 70. The third bosses 72A are provided in the first region G1 on one side where the first wire portion 50R is disposed and the first region G1 on the other side where the second wire portion 50L is disposed. That is, the third bosses 72A are disposed on the outside of the second wire segment 52 of the first wire portion 50R and the outside of the second wire segment 52 of the second wire portion 50L.

The third bosses 72A protrude rearward from the flange portion 74 at the front end of the gear case 4A. The third bosses 72A have cutout portions 72C on their outer circumferential portions facing the radial center of the cylindrical part 70. The cutout portions 72C prevent the switching wire 50 from coming in contact with the third bosses 72A. That is, portions, which face the outer circumferential surface 70A of the cylindrical part 70 in the radial direction, of the outer circumferential portions of the third bosses 72A are cut out. The surfaces of the cutout portions 72C are substantially parallel to the outer circumferential surface 70A of the cylindrical part 70 which the surfaces of the cutout portions 72C face. When the switching wire 50 is disposed at the front end of the movement range, that is, when the speed changing lever 12 is located at the speed-change position for the high-speed mode, the switching wire 50 is brought closest to the third bosses 72A. The cutout portions 72C are provided to prevent the switching wire 50 from coming in contact with the third bosses 72A in this state. The cutout portions 72C allow the third bosses 72A to be disposed at positions outside the switching wire 50 but close to the radial inside.

The fourth boss 72B is disposed in the second region G2 located below the through holes 4J, on the outer circumference of the cylindrical part 70. The fourth boss 72B is provided between the two third bosses 72A in the left-right direction. The fourth boss 72B is provided between the two second bosses 71B of the bracket boss parts 71 in the second region G2. The fourth boss 72B is located at the lower end of the cylindrical part 70.

In the example of FIG. 23, when the angle around the center axis of the cylindrical part 70 is defined with the upper end of the cylindrical part 70 as being 0 degrees, two third bosses 72A are disposed at positions of approximately 47 degrees on the right side and the left side. One fourth boss 72B is disposed at the position of approximately 180 degrees. In this manner, in the embodiment, the three housing boss parts 72 are arranged in an inverted triangular shape as viewed from the axial direction. The distances in the left-right direction between the third bosses 72A and the second bosses 71B are equal. The three housing boss parts 72 are arranged in a shape of an isosceles triangle facing downward.

### Screw fixing Part

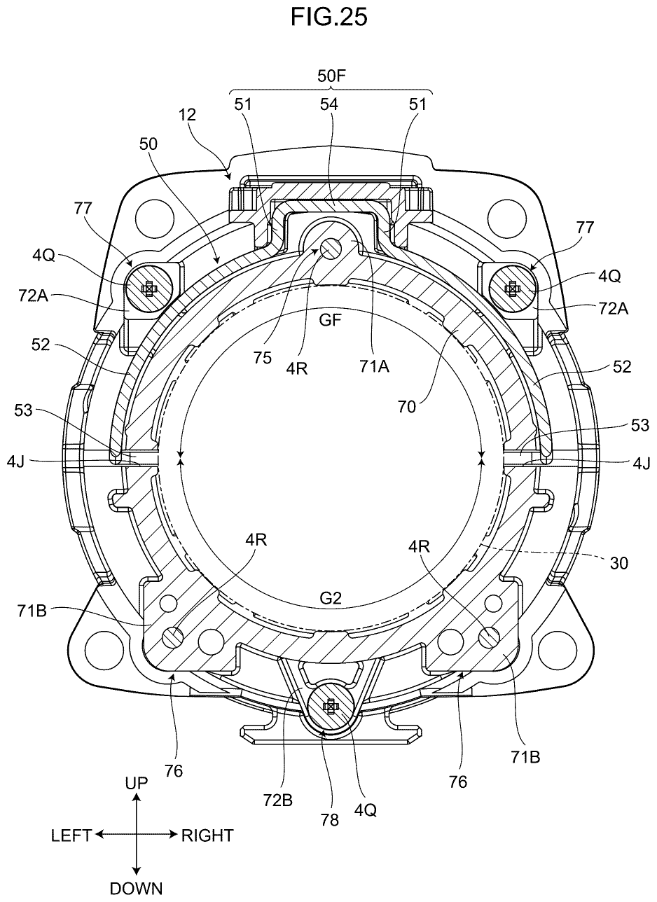

In the above-described configuration, the gear case 4A separately includes a screw fixing part that fixes the motor bracket 4C and a screw fixing part fixed to the gear housing 4B. FIG. 25 is a cross-sectional arrow view of a plane passing through the second wire segments 52 of the switching wire 50 as viewed in the axial direction from rear. In FIG. 25, the speed reducing mechanism 30 inside the gear case 4A is simplified for convenience.

The gear case 4A includes a first screw fixing part 75 disposed at a position facing the held portion 50F of the switching wire 50 in the radial direction as viewed from the axial direction. The first screw fixing part 75 fixes the motor bracket 4C. The first screw fixing part 75 is constituted by the first boss 71A and one screw 4R. An insertion hole 94 is provided in the motor bracket 4C. The screw 4R is inserted into the insertion hole 94. The screw 4R that has passed through the insertion hole 94 from the rear of the motor bracket 4C is mounted into a screw hole 71H of the first boss 71A.

In the gear case 4A, the first screw fixing part 75 is provided at one location in a facing region GF facing the switching wire 50 in the radial direction as viewed from the axial direction. The facing region GF is provided above the through holes 4J. The facing region GF includes both the pair of first regions G1 and the third region G3 between the pair of first regions G1. The first boss 71A is provided in the third region G3.

In the gear case 4A, a plurality of (two) second screw fixing parts 76 is provided in the non-facing region not facing the switching wire 50 in the radial direction as viewed from the axial direction. The second screw fixing parts 76 fix the motor bracket 4C. The non-facing region is a region, in which the switching wire 50 is not provided, of the outer circumferential surface 70A of the cylindrical part 70. The non-facing region is provided below the through holes 4J, and coincides with the second region G2. The second screw fixing parts 76 are constituted by the second bosses 71B and screws 4R. The screws 4R that have passed through insertion holes 94 from the rear of the motor bracket 4C are mounted into screw holes 71H of the second bosses 71B.

Therefore, the gear case 4A is fixed to the motor bracket 4C at three locations by one first screw fixing part 75 and two second screw fixing parts 76. The three locations are arranged in a triangular shape as viewed from the axial direction. The one first screw fixing part 75 is disposed in the facing region GF. The two second screw fixing parts 76 are disposed on one side and the other side in the lateral direction with respect to the center of the gear case 4A in the non-facing region (second region G2).

Furthermore, the gear case 4A includes two third screw fixing parts 77 disposed at a position in the circumferential direction between the first screw fixing part 75 and the second screw fixing part 76 provided on one side and a position in the circumferential direction between the first screw fixing part 75 and the second screw fixing part 76 provided on the other side. One third boss 72A and one screw 4Q constitute one third screw fixing portion 77. The screws 4Q that have passed through the insertion holes 72H of the third bosses 72A from the rear of the gear case 4A are mounted into the screw holes 4H of the gear housing 4B. In the embodiment, the third screw fixing parts 77 are disposed in the facing region GF. The third screw fixing parts 77 are disposed radial outside the second wire segments 52 in the first regions G1, where the second wire segments 52 of the switching wire 50 are disposed, of the facing region GF.

The gear case 4A includes one fourth screw fixing part 78 disposed between the two second screw fixing parts 76 on one side and the other side in the non-facing region (second region G2). The fourth boss 72B and the screw 4Q constitute the fourth screw fixing part 78. The screw 4Q that has passed through the insertion hole 72H of the fourth boss 72B from the rear of the gear case 4A is mounted into the screw hole 4H of the gear housing 4B.

Therefore, the gear case 4A is fixed to the gear housing 4B at three locations arranged in an inverted triangular shape as viewed from the axial direction by the two third screw fixing parts 77 and the one fourth screw fixing part 78.

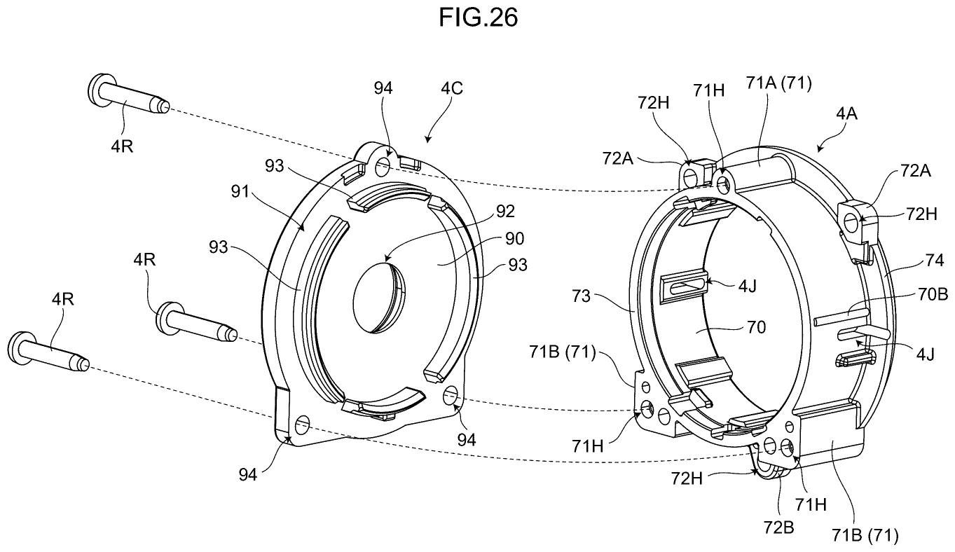

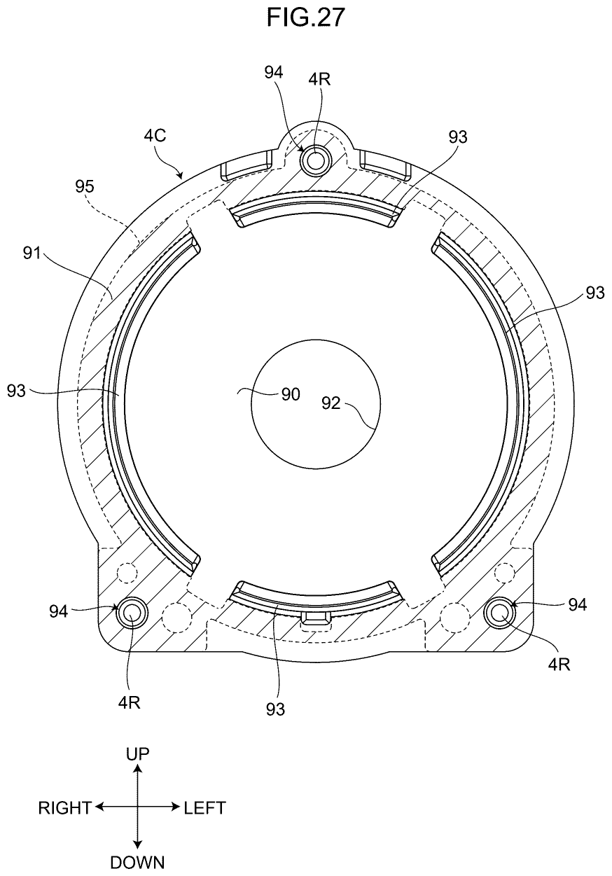

FIG. 26 is a perspective explanatory view illustrating mating surfaces of the gear case 4A and the motor bracket 4C. FIG. 27 is an arrow view of a front surface 90 of the motor bracket 4C as viewed in the axial direction from front.

As illustrated in FIG. 26, the gear case 4A has the first mating surface 73 having an annular flat shape on the rear end surface facing the motor bracket 4C. The first mating surface 73 includes the rear end surface of the cylindrical part 70 and the rear end surfaces of the three bracket boss parts 71 (first boss 71A and second bosses 71B). The first mating surface 73 is flat. Positions on the first mating surface 73 are located at the same position in the front-rear direction.

The motor bracket 4C has a second mating surface 91 having an annular flat shape on the front surface 90 facing the gear case 4A. The second mating surface 91 is in contact with the first mating surface 73.

An opening portion 92 is provided at the center of the motor bracket 4C. The front end portion of the rotor shaft 63 is inserted into the opening portion 92. The bearing 64 is disposed in the opening portion 92. The motor bracket 4C supports the rotor shaft 63 in a rotatable manner via the bearing 64 in the opening portion 92. Four fitting ribs 93 are provided on the front surface 90 of the motor bracket 4C. The fitting ribs 93 protrude forward. The fitting ribs 93 have an arc shape conforming to the inner circumferential surface of the cylindrical part 70 of the gear case 4A. When the motor bracket 4C is attached to the rear end surface of the gear case 4A, the fitting ribs 93 are fitted on the inner circumferential surface of the cylindrical part 70. This achieves positional alignment in the radial direction between the center axis of the motor bracket 4C (i.e., center axis of rotor shaft 63) and the center axis of the gear case 4A (i.e., center axis of speed reducing mechanism 30).

The second mating surface 91 is formed between the fitting ribs 93 and the outer peripheral edge of the motor bracket 4C. The second mating surface 91 surrounds the outer circumference of the fitting ribs 93. The insertion holes 94 for the screws 4R are provided on the second mating surface 91. The second mating surface 91 is flat. Positions on the second mating surface 91 are located at the same position in the front-rear direction.

As illustrated in FIG. 27, when the motor bracket 4C is attached to the rear end surface of the gear case 4A, the first mating surface 73 comes in contact with the second mating surface 91 in the front-rear direction. FIG. 27 illustrates a contact area 95 with the first mating surface 73 of the second mating surface 91. In FIG. 27, the contact area 95 is hatched, and the outer edge thereof is surrounded with dotted lines. Flat surfaces come in surface contact with each other in the contact area 95. The first mating surface 73 and the second mating surface 91 come in close contact with each other by axial force of the screws 4R. This blocks lubricant such as grease applied to each gear of the speed reducing mechanism 30 from leaking from inside of the gear case 4A.

### Advantageous Effects

As described above, in the embodiment, the power tool 1 includes the motor 6, the output part 8, the speed reducing mechanism 30, the gear case 4A, the motor bracket 4C, the speed changing lever 12 (switching operation part), and the switching wire 50. The output part 8 is provided forward of the motor 6 and configured to be driven by the motor 6. The speed reducing mechanism 30 is disposed between the motor 6 and the output part 8 and has a gear shifting function. The gear case 4A includes: the cylindrical part 70 having the through holes 4J penetrating therethrough in the radial direction; and the plurality of bracket boss parts 71 provided on the outer circumference of the cylindrical part 70, and houses the speed reducing mechanism 30 inside the cylindrical part 70. The motor bracket 4C is disposed between the motor 6 and the speed reducing mechanism 30 and is fixed to the plurality of bracket boss parts 71 by the screws 4R. The speed changing lever 12 (switching operation part) is configured to cause the speed reducing mechanism 30 to change gear shifting by being moved. The switching wire 50 passes through the through holes 4J of the gear case 4A and couples the speed changing lever 12 with the speed reducing mechanism 30. The switching wire 50 includes the first and second wire portions 50R and 50L, each including the first wire segment 51, the second wire segment 52, and the third wire segments 53. The first wire segments 51 extend from the speed changing lever 12 to the cylindrical part 70 as viewed from the axial direction. The second wire segments 52 extend in the circumferential direction along the outer circumferential surface 70A of the cylindrical part 70 from the ends of the first wire segments 51. The third wire segments 53 extend from the ends of the second wire segments 52 and are inserted into the through holes 4J. The bracket boss parts 71 are provided at positions other than the first regions G1 facing the second wire segments 52 in the radial direction, on the outer circumference of the cylindrical part 70.

In the above-described configuration, the bracket boss parts 71 of the gear case 4A are provided at the positions other than the first regions G1 facing the second wire segments 52 in the radial direction, on the outer circumference of the cylindrical part 70. If the bracket boss parts 71 are provided in the first regions G1, the second wire segments 52 of the switching wire 50 go around the outside of the bracket boss parts 71. In contrast, in the present configuration, the second wire segments 52 of the switching wire 50 connect the first wire segments 51 with the third wire segments 53 without going around the outside of the bracket boss parts 71. This can shorten the path length of the switching wire 50 leading to the speed reducing mechanism 30, thereby increasing the spring constant (rigidity) of the switching wire 50. Increasing the spring constant of the switching wire 50 makes the switching wire 50 less likely to be easily bent, and enables a gear coupled via the switching wire 50 to be supported even when reaction force acts on the gear. As a result, positional shift of a gear for gear shifting of the speed reducing mechanism 30 is less likely to occur, whereby more reliable gear shifting is achieved.

In the embodiment, the through holes 4J include two through holes 4J provided on one side and the other side in a lateral direction. The first wire portion 50R is provided on the one side and is inserted into the through hole 4J on the one side. The second wire portion 50L is provided on the other side, and is inserted into the through hole 4J on the other side. The plurality of bracket boss parts 71 includes the first boss 71A disposed between the first wire segment 51 of the first wire portion 50R and the first wire segment 51 of the second wire portion 50L.

In the above-described configuration, the first boss 71A of the bracket boss part 71 can be disposed by utilizing the space between the first wire portion 50R and the second wire portion 50L. Thus, installation space for the bracket boss part 71 (first boss 71A) can be secured without increasing the dimensions of the gear case 4A and the motor bracket 4C while shortening the path length of the switching wire 50.

In the embodiment, the speed changing lever 12 is disposed upward of the gear case 4A. The bracket boss parts 71 include the second bosses 71B disposed in the second region G2 located below the through holes 4J on the outer circumference of the cylindrical part 70.

In the above-described configuration, by arranging the second bosses 71B in the second region G2 located below the through holes 4J where the switching wire 50 is not positioned within the gear case 4A, the number of fixing locations for the motor bracket 4C can be increased without diverting the path of the switching wire 50. The gear case 4A and the motor bracket 4C can be firmly fixed to each other by the first boss 71A and the second bosses 71B. Thus, leakage of lubricant (grease) and the like can be suppressed, for example.

In the embodiment, the second bosses 71B are disposed on one side (right side) and the other side (left side) in the lateral direction of the cylindrical part 70 in the second region G2.

In the above-described configuration, by arranging the plurality of second bosses 71B in the second region G2 where the switching wire 50 is not positioned within the gear case 4A, a plurality of fixing locations for the motor bracket 4C to the gear case 4A can be distributed over a wider circumferential range. As a result, the first boss 71A and the plurality of second bosses 71B can fix the motor bracket 4C more evenly. Even in the case, the switching wire 50 does not need to go around the outside of bosses, and reliability of gear shifting can be enhanced.

In the embodiment, the radial distance CL between the second wire segment 52 of the switching wire 50 and the outer circumferential surface 70A of the cylindrical part 70 in the first region G1 is smaller than a protrusion amount EP of the bracket boss part 71 with respect to the outer circumferential surface 70A in the first region G1.

In the above-described configuration, the second wire segment 52 of the switching wire 50 is disposed radially inside the outer circumferential portion of the bracket boss part 71, and the distance CL between the second wire segment 52 of the switching wire 50 and the outer circumferential surface 70A of the cylindrical part 70 of the gear case 4A is sufficiently decreased. This can effectively shorten the path length of the second wire segment 52 of the switching wire 50. Therefore, the spring constant of the switching wire 50 can be effectively increased to further improve the performance of holding the position of the gear for gear shifting.

In the embodiment, the power tool 1 further includes the gear housing 4B, which is provided forward of the gear case 4A and to which the front end of the gear case 4A is fixed. The gear case 4A includes the plurality of housing boss parts 72, which is disposed radially outside the switching wire 50 and is fixed to the gear housing 4B by the screws 4Q.

In the above-described configuration, the gear case 4A can be fixed to the gear housing 4B by the plurality of housing boss parts 72 separately from the bracket boss parts 71. Also in the case, the plurality of housing boss parts 72 is disposed radially outside the switching wire 50. Thus, the switching wire 50 does not need to go around the outside of the housing boss parts 72, and an increase in the path length of the switching wire 50 can be avoided.

In the embodiment, the housing boss parts 72 includes the third bosses 72A disposed radially outside the second wire segments 52 of the switching wire 50 in the first regions G1.

In the above-described configuration, in the first regions G1 where the bracket boss parts 71 are not disposed, arrangement space for the housing boss parts 72 (third bosses 72A) can be secured without diverting the second wire segments 52 of the switching wire 50.

In the embodiment, the third bosses 72A have the cutout portions 72C on the outer circumferential portion thereof facing the radial center of the cylindrical part 70, to prevent the switching wire 50 from coming in contact with the third bosses 72A.

In the above-described configuration, the cutout portions 72C are provided in the third bosses 72A disposed radially outside the second wire segments 52 of the switching wire 50. With this, the radial positions of the third bosses 72A can be brought closer to the second wire segments 52. This can inhibit an increase in the dimension of the outer shape of the gear case 4A even having a configuration in which the third bosses 72A are disposed outside the second wire segments 52 of the switching wire 50.

In the embodiment, the gear case 4A has the through hole 4J on each of one side and the other side in a lateral direction. The switching wire 50 includes the first wire portion 50R and the second wire portion 50L. The first wire portion 50R includes the first wire segment 51, the second wire segment 52, and the third wire segment 53, and is inserted into the through hole 4J on one side. The second wire portion 50L includes the first wire segment 51, the second wire segment 52, and the third wire segment 53, and is inserted into the through hole 4J on the other side. The third bosses 72A are disposed on the outside of the second wire segment 52 of the first wire portion 50R and the outside of the second wire segment 52 of the second wire portion 50L.

In the above-described configuration, the third bosses 72A are disposed on the outside of the second wire segment 52 of the first wire portion 50R and the outside of the second wire segment 52 of the second wire portion 50L. Thus, the fixing locations of the gear case 4A and the gear housing 4B can be distributed over a wider range. This enables the gear case 4A to be fixed more evenly.

In the embodiment, the speed changing lever 12 is disposed upward of the gear case 4A. The housing boss parts 72 includes the fourth boss 72B disposed in the second region G2 located below the through holes 4J on the outer circumference of the cylindrical part 70.

In the above-described configuration, by arranging the fourth boss 72B in the second region G2 where the switching wire 50 is not positioned within the gear case 4A, a plurality of fixing locations for the gear case 4A to the gear housing 4B can be distributed over a wider circumferential range. As a result, the third bosses 72A and the fourth boss 72B can fix the gear case 4A more evenly.

In the embodiment, the power tool 1 includes the motor 6, the output part 8, the speed reducing mechanism 30, the gear case 4A, the motor bracket 4C, the speed changing lever 12 (switching operation part), and the switching wire 50. The output part 8 is provided forward of the motor 6 and configured to be driven by the motor 6. The speed reducing mechanism 30 is disposed between the motor 6 and the output part 8 and has a gear shifting function. The gear case 4A includes the cylindrical part 70 having the through holes 4J penetrating therethrough in a radial direction and houses the speed reducing mechanism 30 inside the cylindrical part 70. The motor bracket 4C is disposed between the motor 6 and the speed reducing mechanism 30 and fixed to the gear case 4A by the screws 4R. The speed changing lever 12 (switching operation part) is configured to cause the speed reducing mechanism 30 to change gear shifting by being moved. The switching wire 50 passes through the through holes 4J of the gear case 4A and couples the speed changing lever 12 with the speed reducing mechanism 30. The switching wire 50 includes the held portion 50F held by the speed changing lever 12. The gear case 4A includes a first screw fixing part 75, which is provided at a position facing the held portion 50F of the switching wire 50 in the radial direction as viewed from the axial direction and fixes the motor bracket.

In the above-described configuration, in the gear case 4A, the first screw fixing part 75 for fixing the motor bracket 4C is disposed at a position facing the held portion 50F of the switching wire 50 in the radial direction as viewed from the axial direction. If the first screw fixing part 75 is provided in the middle of a path to the speed reducing mechanism 30, the switching wire 50 goes around the outside of the first screw fixing part 75. In contrast, in the present configuration, the switching wire 50 can be connected to a coupling portion with the speed reducing mechanism 30 without going around the outside of the first screw fixing part 75 from the held portion 50F. This can shorten the path length of the switching wire 50 leading to the speed reducing mechanism 30 of the switching wire 50, thereby increasing the spring constant (rigidity) of the switching wire 50. Increasing the spring constant of the switching wire 50 makes the switching wire 50 less likely to be easily bent, and enables a gear coupled via the switching wire 50 to be supported even when reaction force acts on the gear. As a result, positional shift of a gear for gear shifting of the speed reducing mechanism 30 is less likely to occur, whereby more reliable gear shifting is achieved.

In the embodiment, in the gear case 4A, the first screw fixing part 75 is provided at one location in the facing region GF facing the switching wire 50 in the radial direction as viewed from the axial direction. In the gear case 4A, the plurality of second screw fixing parts 76, which fixes the motor bracket 4C, is provided in the non-facing region (second region G2) not facing the switching wire 50 in the radial direction as viewed from the axial direction.

In the above-described configuration, only one first screw fixing part 75 is provided in the facing region GF, whereby the switching wire 50 does not need to go around the screw fixing parts. The plurality of second screw fixing parts 76 is provided in the non-facing region, whereby, the motor bracket 4C and the gear case 4A can be evenly fixed to each other at a plurality of locations while avoiding an increase in the path length of the switching wire 50.

In the embodiment, the gear case 4A and the motor bracket 4C are fixed to each other at three locations arranged in a triangular shape as viewed from the axial direction, by one first screw fixing part 75 disposed in the facing region GF and two second screw fixing parts 76 disposed on one side and the other side in the lateral direction with respect to the center of the gear case 4A in the non-facing region (second region G2).

In the above-described configuration, by fixing the motor bracket 4C and the gear case 4A at the three locations arranged in the triangular shape as viewed from the axial direction, the motor bracket 4C and the gear case 4A can be evenly and firmly fixed to each other while avoiding an increase in the path length of the switching wire 50.

In the embodiment, the gear case 4A has the first mating surface 73 having an annular flat shape on the rear end surface facing the motor bracket 4C. The motor bracket 4C has the second mating surface 91 having an annular flat shape, which is in contact with the first mating surface 73, on the front surface 90 facing the gear case 4A.

In the above-described configuration, the first mating surface 73 of the gear case 4A and the second mating surface 91 of the motor bracket 4C both having a flat surface can be brought into surface contact with each other. This can effectively inhibit leakage of lubricant (grease) inside the gear case 4A and the like even when vibration caused by driving of the motor 6 is generated.

In the embodiment, the power tool 1 further includes the gear housing 4B, which is provided forward of the gear case 4A and to which the front end of the gear case 4A is fixed. The gear case 4A includes two third screw fixing parts 77 disposed at a position in the circumferential direction between the first screw fixing part 75 and the second screw fixing part 76 disposed on the one side and a position in the circumferential direction between the first screw fixing part 75 and the second screw fixing part 76 provided on the other side.

In the above-described configuration, screw tightening locations (third screw fixing parts 77) where the gear case 4A and the gear housing 4B are screw-tightened can be disposed at positions shifted in a circumferential direction with respect to screw tightening locations (first screw fixing part 75 and second screw fixing parts 76) where the gear case 4A and the motor bracket 4C are screw-tightened. This can improve workability of screw tightening work.

In the embodiment, the gear case 4A includes one fourth screw fixing part 78 disposed between the two second screw fixing parts 76 provided on one side and the other side in the non-facing region (second region G2). The gear case 4A and the gear housing 4B are fixed to each other at three locations arranged in an inverted triangular shape as viewed from the axial direction by the two third screw fixing parts 77 and the one fourth screw fixing part 78.

In the above-described configuration, the motor bracket 4C and the gear case 4A are fixed to each other at three locations arranged in the triangular shape as viewed from the axial direction. The gear case 4A and the gear housing 4B are fixed to each other at three locations arranged in the inverted triangular shape as viewed from the axial direction. Thus, the fixation of the motor bracket 4C with the gear case 4A and fixation of the gear case 4A with the gear housing 4B can be evenly performed, and the workability of screw tightening work for each fixation can be improved.

### Other Embodiments

In the above-described embodiment, the battery pack 20 mounted on the battery mounting part 5 is used as a power source of the power tool 1. A commercial power source (AC power source) may be used as the power source of the power tool 1.

Although, in the above-described embodiment, an example in which the power tool 1 is a hammer driver drill has been described, the power tool may be a power tool other than the hammer driver drill. The power tool is not particularly limited as long as the power tool includes a speed reducing mechanism having a gear shifting function and has a structure that couples a switching operation part with the speed reducing mechanism using a switching wire.

Although, in the above-described embodiment, an example in which three bracket boss parts 71 are provided has been described, two or four or more bracket boss parts 71 may be provided. Although, in the above-described embodiment, an example in which three housing boss parts 72 are provided has been described, two or four or more housing boss parts 72 may be provided.

### ADDITIONAL ASPECT

An additional aspect of the present teachings includes:
Aspect A
   A power tool including:
   a motor;
   an output part that is provided forward of the motor and configured to be driven by the motor;
   a speed reducing mechanism disposed between the motor and the output part;
   a gear case that houses the speed reducing mechanism; and
   a motor bracket disposed between the motor and the speed reducing mechanism and fixed to the gear case,
   wherein the gear case includes a first mating surface having an annular flat shape on a rear end surface facing the motor bracket, and
   the motor bracket includes a second mating surface having an annular flat shape, which is in contact with the first mating surface, on a front surface facing the gear case.

In the power tool according to Aspect A, the speed reducing mechanism is not required to have the gear shifting function. Thus, the switching operation part and the switching wire are not required to be provided.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A power tool comprising:
a motor;
an output part that is provided forward of the motor and configured to be driven by the motor;
a speed reducing mechanism disposed between the motor and the output part and having a gear shifting function;
a gear case that includes: a cylindrical part having at least one through hole penetrating therethrough in a radial direction; and a plurality of bracket boss parts provided on an outer circumference of the cylindrical part, and that houses the speed reducing mechanism inside the cylindrical part;
a motor bracket disposed between the motor and the speed reducing mechanism and fixed to the bracket boss parts by screws;
a switching operation part configured to cause the speed reducing mechanism to change gear shifting by being moved; and
a switching wire that passes through the through hole of the gear case and couples the switching operation part with the speed reducing mechanism,
wherein the switching wire includes at least one wire portion including first to third wire segments, the first wire segment extending from the switching operation part to the cylindrical part as viewed from an axial direction, the second wire segment extending in a circumferential direction along an outer circumferential surface of the cylindrical part from an end of the first wire segment, and the third wire segment extending from an end of the second wire segment and being inserted into the through hole, and
the bracket boss parts are provided at positions other than a first region facing the second wire segment in a radial direction, on the outer circumference of the cylindrical part.

2. The power tool according to claim 1,
wherein the at least one through hole includes two though holes provided on one side and another side in a lateral direction of the gear case,
the at least one wire portion includes:
a first wire portion, which is provided on the one side and is inserted into the through hole provided on the one side; and
a second wire portion, which is provided on the other side and is inserted into the through hole provided on the other side, and
the bracket boss parts include a first boss disposed between the first wire segment of the first wire portion and the first wire segment of the second wire portion.

3. The power tool according to claim 2,
wherein the switching operation part is disposed upward of the gear case, and
the bracket boss parts include at least one second boss disposed in a second region located below the through holes on the outer circumference of the cylindrical part.

4. The power tool according to claim 3,
wherein the at least one second bosses include two second bosses disposed on the one side and the other side in the lateral direction of the cylindrical part in the second region.

5. The power tool according to claim 1,
wherein a radial distance between the second wire segment of the switching wire and an outer circumferential surface of the cylindrical part in the first region is smaller than a protrusion amount of the bracket boss part with respect to the outer circumferential surface in the first region.

6. The power tool according to claim 1, further comprising
a gear housing, which is provided forward of the gear case and to which a front end of the gear case is fixed,
wherein the gear case includes a plurality of housing boss parts, which is disposed radially outside the switching wire and is fixed to the gear housing by screws.

7. The power tool according to claim 6,
wherein the housing boss parts include at least one third boss disposed radially outside the second wire segment of the switching wire in the first region.

8. The power tool according to claim 7,
wherein the third boss has a cutout portion on an outer circumferential portion thereof facing a radial center of the cylindrical part, to prevent the switching wire from coming in contact with the third boss.

9. The power tool according to claim 7,
wherein the at least one through hole includes two through holes provided on one side and another side in a lateral direction of the gear case,
the at least one wire portion includes:
a first wire portion, which is disposed on the one side and is inserted into the through hole provided on the one side; and
a second wire portion, which is disposed on the other side and is inserted into the through hole provided on the other side, and
the at least one third boss include two third bosses disposed on an outside of the second wire segment of the first wire portion and an outside of the second wire segment of the second wire portion.

10. The power tool according to claim 7,
wherein the switching operation part is disposed upward of the gear case, and
the housing boss parts include a fourth boss disposed in a second region located below the through hole on the outer circumference of the cylindrical part.

11. A power tool comprising:
a motor;
an output part that is provided forward of the motor and configured to be driven by the motor;
a speed reducing mechanism disposed between the motor and the output part and having a gear shifting function;
a gear case that includes a cylindrical part having at least one through hole penetrating therethrough in a radial direction and that houses the speed reducing mechanism inside the cylindrical part;
a motor bracket disposed between the motor and the speed reducing mechanism and fixed to the gear case by screws;
a switching operation part configured to cause the speed reducing mechanism to change gear shifting by being moved; and
a switching wire that passes through the through hole of the gear case and couples the switching operation part with the speed reducing mechanism,
wherein the switching wire includes a held portion held by the switching operation part, and
the gear case includes a first screw fixing part, which is provided at a position facing the held portion of the switching wire in the radial direction as viewed from an axial direction and fixes the motor bracket.

12. The power tool according to claim 11,
wherein
in the gear case, the first screw fixing part is provided at one location in a facing region facing the switching wire in the radial direction as viewed from the axial direction, and
in the gear case, a plurality of second screw fixing parts, which fixes the motor bracket, is provided in a non-facing region not facing the switching wire in the radial direction as viewed from the axial direction.

13. The power tool according to claim 12,
wherein the gear case and the motor bracket are fixed to each other at three locations arranged in a triangular shape as viewed from the axial direction, by one first screw fixing part disposed in the facing region and two second screw fixing parts disposed on one side and another side in a lateral direction with respect to a center of the gear case in the non-facing region.

14. The power tool according to claim 11,
wherein the gear case has a first mating surface having an annular flat shape on a rear end surface facing the motor bracket, and
the motor bracket has a second mating surface having an annular flat shape, which is in contact with the first mating surface, on a front surface facing the gear case.

15. The power tool according to claim 13, further comprising
a gear housing, which is provided forward of the gear case and to which a front end of the gear case is fixed,
wherein the gear case includes two third screw fixing parts disposed at a position in a circumferential direction between the first screw fixing part and a second screw fixing part disposed on the one side and a position in the circumferential direction between the first screw fixing part and a second screw fixing part disposed on the other side.

16. The power tool according to claim 15,
wherein the gear case includes one fourth screw fixing part disposed between the two second screw fixing parts disposed on the one side and the other side in the non-facing region, and
the gear case and the gear housing are fixed to each other at three locations arranged in an inverted triangular shape as viewed from the axial direction by the two third screw fixing parts and the one fourth screw fixing part.
